(19) United States
(12) Patent Application Publication
(10) Pub. No.: US 2024/0175160 A1
(43) Pub. Date: May 30, 2024

(54) ELECTROLYTIC CELL LID HANDLING SYSTEM AND METHOD OF USE

(71) Applicant: ALUMATIQ AS, Mosjoen (NO)

(72) Inventors: Frode Breimo, Mosjoen (NO); Thomas Sperle, Trondheim (NO); Johan Moflag, Mo I Rana (NO); Jan-Hugo Lynghei, Mo I Rana (NO)

(21) Appl. No.: 18/284,583

(22) PCT Filed: Mar. 31, 2022
(86) PCT No.: PCT/EP2022/058732

§ 371 Date: Sep. 28, 2023

(30) Foreign Application Priority Data
Mar. 31, 2021 (GB) 2104620.6

(51) Int. Cl. C25C 3/10; B25J 5/00; B25J 9/16

(52) U.S. Cl. CPC C25C 3/10; B25J 5/00; B25J 9/1664; B25J 9/1697

(57) ABSTRACT

The invention provides a system for handling pot lids in an aluminium production plant. The system comprises a robot assembly and a sensor system. The robot assembly comprises at least one manipulator arm and a lid gripper apparatus configured to grip at least one protruding or upstanding formation on a pot lid. The lid gripper apparatus is mounted at one end of the at least one manipulator arm. The sensor system is operable to generate position information to control the position of the at least one manipulator arm and/or lid gripper apparatus.

The present invention relates to anode replacement and other operations of electrolytic cells in an aluminium production plant and in particular to a system and methods for handling lids of aluminium production electrolytic cells.

### BACKGROUND TO THE INVENTION

Aluminium is produced industrially by smelting using the Hall-Héroult process which involves dissolving alumina (aluminium oxide) in an electrolyte bath consisting of molten cryolite to produce 99.5-99.8% pure aluminium.

The electrolysis process is conducted in a purpose-built cell called a pot. Typically, the pot is made of steel with an insulating lining of refractory materials. A cathode is located at the inner base of the pot. An anode in the form of a carbon rod or block is suspended in the electrolyte in the pot and oxide ions from dissolved alumina are discharged onto the anode. Aluminium is formed from the aluminium anions being reduced at the electrolyte/aluminium interface. The molten aluminium formed sinks below the electrolyte to the bottom of the pot.

Over time the oxide ions react with the anode and gradually consume the carbon anode forming gaseous carbon dioxide (CO2). The consumed anode requires regular replacement to allow aluminium production to continue.

Aluminium smelters consist of a large number of pots (cells) in a pot room in which the electrolysis takes place. A typical smelter contains hundreds of pots. The pots are connected in series with a cathode of one pot electrically connected to the next pot to form a potline. The process is operated as a batch process with the aluminium metal deposited at the bottom of the pots and periodically siphoned off.

The electrolysis process requires large amount of electricity with a potline requiring an amperage of between 150 kA to 500 kA to keep the electrolyte bath at an operating temperature of around 950° C. and to generate the alumina reduction reaction.

The working environment around the potlines can be hazardous to personnel with a high ambient temperature due to the heat emitted from the cells. In addition, operators may be exposed to gaseous emissions and harmful particulates. The gaseous emissions produced during the process include gaseous hydrogen fluoride, with sodium fluoride, aluminium fluoride, sulphur dioxide, carbon dioxide and unused particulates of cryolite. This may be complicated by gaseous emissions such as sulphur dioxide and hydrogen fluoride reacting with moisture in the pot room and forming acids.

Most pots have removable lids which provide a physical barrier between the pot room and the electrolytic pot which protects personnel from accidently falling into the pot. The lids act as a cover for the pot providing an enclosed environment which protects the carbon anode from oxidation from the air in the pot room and assists in maintaining the temperature of the electrolyte bath. The lids also assist in containing the toxic gasses and dust created during the smelting process in the enclosed environment, reducing exposure to personnel in the pot room. However, personnel are exposed to the risk of falling in the pot, toxic gas emissions, harmful particulates and high temperatures during regular anode replacement operations where an operator is required to remove the lid to replace the anode before replacing the lid. The personnel may also be injured by manhandling heavy hot lids and equipment. The close proximity to an uncovered pot exposes the operators to splashes or sprays of molten cryolite. The pot room personnel may also be exposed to risk if the lid is misaligned or not replaced correctly.

EP3114257 discloses a system for lifting pot lids using a pneumatic suction cup apparatus which contacts an outer surface of a lid to lift the lid from a pot. However, this system has limited applications as it requires that the lid have a clean outer surface and a flat surface to make a good suction contact. Most lid designs have steps integrated on an outer surface to allow worker to stand on the lid to access elevated sections of the pot structure. The system of EP3114257 is not suitable to lift these lid designs as there is limited surface area where the suction cups could be applied, and the centre of mass would be skewed due to the presence of the steps.

### SUMMARY OF THE INVENTION

It is an object of an aspect of the present invention to provide a lid handling system capable of safely and accurately handling pot lids during aluminium production.

It is another object of at least one aspect of the present invention to provide a lid handling system and method for mitigating the exposure of personnel to falling in a pot, molten bath splashes, toxic gas emissions, harmful particulates and/or high temperatures during pot maintenance operations such as anode replacement.

It is a further object of an aspect of the present invention to provide a lid handling system capable of conducting lid handling operations reliably, autonomously and to a high degree of accuracy.

It is a further object of an aspect of the present invention to provide method which allows the safe removal and replacement of one or more pot lids quickly and accurately.

Further aims and objects of the invention will become apparent from reading the following description.

According to a first aspect of the invention, there is provided a system for handling pot lids in an aluminium production plant comprising:
a robot assembly comprising at least one manipulator arm;
a lid gripper apparatus configured to grip at least one protruding or upstanding formation on a pot lid, the lid gripper apparatus mounted at one end of the at least one manipulator arm; and
a sensor system;
wherein the sensor system is operable to generate position information to control the position of the at least one manipulator arm and/or lid gripper apparatus.

The at least one protruding or upstanding formation on a pot lid may be a handle and/or at least one step. The at least one protruding or upstanding formation on a pot lid may be an edge of the pot lid. The at least one protruding or upstanding formation may be a formation protruding or upstanding from a surface and/or side on the lid. The surface may be an upper surface of the pot lid.

The lid gripper apparatus may be configured to contact at least two surfaces or sides of the at least one protruding or upstanding formation. The lid gripper apparatus may be configured to grip the at least one protruding or upstanding formation by clamping the at least one protruding or upstanding formation. The lid gripper apparatus may be configured to contact at least two surfaces or sides of the at least one protruding or upstanding formation to clamp the at least one protruding or upstanding formation.

The lid gripper apparatus may be configured to apply or exert opposing forces on two or more surfaces or sides of the at least one protruding or upstanding formation. The lid gripper apparatus may be configured to move at least two surfaces toward each other to exert opposing forces on the at least one protruding or upstanding formation. The lid gripper apparatus may be configured to grip the at least one formation by at least partially encircling or at least partially clamping part of the at least one protruding or upstanding formation.

By providing a lid gripper apparatus capable of gripping at least one protruding or upstanding formation on a lid such as a handle or at least one step the lid is held securely and stable. The lid may be gripped close to a centre of mass of the lid allowing a balanced movement without damaging the lid and applying minimal balancing counter-torque or tension on the equipment. The system may be configured to move and lift the lid by the handle or at least one step. The lid gripper apparatus may be configured to transmit energy and forces to the lid via the gripped at least one protruding or upstanding formation.

The system may be configured to be movably mounted on a support. The system may be configured to be vertically and/or horizontally movable on a support. The system may comprise a support. The support may be a stationary or a mobile support. The support may be a vehicle, a component of a vehicle and/or configured to be mounted to a vehicle. The support may be a crane, a component of crane and/or configured to be mounted to a crane. The support may be an overhead crane.

The system may be configured to be movably mounted on a support by one or more springs. The system may be mounted on a support by a spring suspension system. The spring suspension system may comprise one or more rigid or stiff springs. The spring suspension system may comprise one or more shock absorbers. The spring suspension system may be configured to minimise or mitigate forces acting on the robot assembly being transferred to the support. The spring suspension system may be configured to minimise or mitigate forces acting on the support being transferred to the robot assembly. The system may be configured to be movably mounted on a positioning system or a positioning member of a positioning system. The positioning system may be movably mounted on a crane or vehicle. The positioning system may comprise a support having a longitudinal axis. A first positioning member may be movably mounted on the support.

The first positioning member may comprise a first axis and a second axis. The first positioning member may be configured to move along the longitudinal axis of the support with the first axis parallel to the longitudinal axis of the support. A second positioning member may be mounted to the first positioning member. The second positioning member may be configured to move transversely to the first axis of the first positioning member.

The support, crane, vehicle, positioning system, first positioning member and/or a second positioning member may comprise a plurality of positional markers. The plurality of positional markers may be selected from the group comprising barcodes, data matrix codes, quick response codes and/or colour codes.

The sensor system may comprise at least one sensor. The at least one sensor may be selected from the group comprising: optical sensor, vision system, camera, time of flight camera, depth sensor, distance sensor, laser, ultrasound, momentum sensor, accelerometer, rotary position sensor, gyroscopic position sensor, global positioning sensor, infra-red sensor, thermal sensor, load cell and/or LIDAR.

The system may comprise at least one processing unit. The sensor system may be connected to at least one processing unit. The system may comprise at least one control unit. The sensor system and/or the at least one processing unit may be connected to at least one control unit.

The sensor system may be configured to detect at least one of the plurality of positional markers to accurately locate and/or move the position of the support, crane, vehicle, positioning system, first positioning member and/or a second positioning member.

The sensor system may be operable to generate position information of the position of the support, crane, vehicle, positioning system, first positioning member and/or second positioning member. The sensor system may be operable to generate information of the position of the support, crane, vehicle, positioning system, first positioning member and/or second positioning member in relation to the at least one manipulator arm and/or lid gripper apparatus. The sensor system may be configured to generate 2D and/or 3D position information for the support, crane, vehicle, positioning system, first positioning member, second positioning member, suspended robot assembly, at least one manipulator arm and/or lid gripper apparatus.

The sensor system may be configured to communicate the position information of the support, crane, vehicle, positioning system, first positioning member, second positioning member, robot assembly, at least one manipulator arm and/or lid gripper apparatus to the at least one processing unit. The at least one processing unit may be configured to process a movement path for the support, crane, vehicle, positioning system, first positioning member, second positioning member, robot assembly, at least one manipulator arm and/or lid gripper apparatus based on the position information generated by the sensor system. The sensor system may be configured to monitor the position information to prevent a collision in the work area surrounding the pot.

The position information may comprise at least one of a position of a crane, robot, a manipulator arm, a lid gripper apparatus, a gripper part of the lid gripper apparatus, a lid and/or at least one protruding or upstanding formation of a lid.

The sensor system may be configured to generate 2D and/or 3D position information of a pot, a pot lid, at least one protruding or upstanding formation, a lid handle, at least one step, a potline, a pot room and/or a part of the pot room. The sensor system may be configured to generate 2D and/or 3D position information of potential obstacles in a work area surrounding a pot of interest. The sensor system may be configured to generate 2D and/or 3D position information of components of the lid handling system in relation to the pot, a potline, a pot room and/or a part of the pot room.

At least one sensor of the sensor system may be mounted on support, vehicle, crane, positioning system and/or at least one positioning member, pot, a pot lid, at least one protruding or upstanding formation, a lid handle, at least one step, a potline, a pot room and/or a part of the pot room. At least one sensor of the sensor system is mounted on the robot assembly, at least one manipulator arm and/or lid gripper apparatus.

The sensor system may comprise a vision system. The vision system may be configured to accurately obtain accurate positional data on components of the least one manipulator arm and/or lid gripper apparatus and their surrounding environment. The vision system may comprise at least one sensor. The vision system may comprise at least one optical sensor, camera, time of flight camera, depth sensor, distance sensor and/or laser. Preferably the vision system comprises at least one time of flight camera.

The sensor system may be configured to generate position information for the robot assembly, the lid gripper apparatus, the lid and/or the at least one protruding or upstanding formation. The sensor system may be configured to generate position information to identify a particular potline, pot, lid and/or the at least one protruding or upstanding formation. The sensor system may be configured to communicate the position information of the robot assembly, a lid gripper apparatus, a lid and/or at least one protruding or upstanding formation to the at least one processing unit. The at least one processing unit may be configured to process a movement path for the robot assembly, the lid gripper apparatus, the lid and/or the at least one protruding or upstanding formation based on the position information generated by the sensor system. The sensor system may be configured to monitor the position information to prevent a collision in the work area surrounding the pot. The sensor system may be configured to identify the position of a specific pot lid in the pot room. The sensor system may be configured to inspect the status or condition of a specific at least one protruding or upstanding formation such as pot lid handle or at least one step.

The at least one control unit may be configured to move the crane, robot assembly, at least one manipulator arm of the robot and/or the lid gripper apparatus in relation to the pot, lid and/or at least one protruding or upstanding formation. The at least one control unit may be a programmable logic controller. The sensor system, at least one processing unit and at least one control unit may be part of a sensor, processing and control system for positioning and controlling the lid handling system.

The system may be an autonomous system. The system may be an automated system. The system may be a semi-autonomous system or semi-automated system. The system may be controlled by a user controlling remote manipulators.

The lid gripper apparatus may be configured to grip a handle or at least one step of a pot lid. The lid gripper apparatus may comprise at least one grip member. The at least one grip member may be operable to move between an open condition and a closed condition. The at least one grip member may be operable to move to a closed condition to grip at least one protruding or upstanding formation such as a lid handle or at least one step of a pot lid. The at least one grip member may be operable to move to an open condition to release at least one protruding or upstanding formation such as a lid handle or at least one step of a pot lid. The at least one grip member may be a clamp member or a jaw member.

The at least one grip member may be configured to be a fail-closed grip member. The at least one grip member may be configured to move to or remain in a closed condition in the event of a loss of power, drive and/or loss of control signal.

The lid gripper apparatus may comprise at least one jaw member. The at least one jaw member may be operable to move between an open condition and a closed condition. The at least one jaw member may be operable to move to a closed condition to grip at least one protruding or upstanding formation such as a lid handle or at least one step of a pot lid. The at least one jaw member may be operable to move to an open condition to release at least one protruding or upstanding formation such as a lid handle or at least one step of a pot lid.

The at least one manipulator arm may be configured to be movable between a stowed condition and a deployed condition. The robot assembly may be an articulated robot. The robot assembly may be configured to be movable through multiple controlled movements when in a deployed condition. The robot assembly may be configured to be movable through multiple controlled movements from a stowed condition to a deployed condition. The robot assembly may be configured to be movable through multiple controlled movements from a deployed condition to a stowed condition.

The robot assembly may be configured to move the at least one manipulator arm to move the lid gripper apparatus to locate the at least one grip member adjacent to the at least one protruding or upstanding formation of a pot lid. The lid gripper apparatus may comprise two or more engaging surfaces. The robot assembly may be configured to move the at least one manipulator arm to move the lid gripper apparatus to locate the at least one protruding or upstanding formation of a pot lid between the two or more engaging surfaces.

The lid gripper apparatus may comprise two or more grip members. Where the lid gripper apparatus comprises two or more engaging surfaces, they may be located on the grip members. The lid gripper apparatus may comprise two or more jaw or clamp members. Where the lid gripper apparatus comprises two or more engaging surfaces, they may be located on the jaw or clamp members.

The vision system of the sensor system may be configured to acquire positional data for the robot assembly, at least one manipulator arm and/or lid gripper apparatus. The vision system may be in communication with the at least one processing unit and at least one control unit to use sensor data to align the two or more jaw members with the at least one protruding or upstanding formation of a pot lid.

The robot assembly may be configured to move the at least one manipulator arm to move the lid gripper apparatus and a connected or gripped pot lid along a horizontal plane to push or nudge adjacent lids. The robot assembly may be configured to move the at least one manipulator arm to lift the lid gripper apparatus and a connected or gripped pot lid. The robot assembly may be configured to move the at least one manipulator arm to transport the connected pot lid to a lid storage unit. The robot assembly may be configured to move the at least one manipulator arm to maintain the lid at an angle of approximately 45 degrees to the horizontal plane throughout the lifting and transportation of the lid to the lid storage unit.

The robot assembly may comprise a plurality of arm members rotatably connected to each other. The robot assembly may comprise a hub. The hub may be mounted or attached to a suspended support. The robot assembly may comprise a first arm member rotatably connected to the hub. The first arm member may be configured to rotate around a first rotational axis. The first arm member may be configured to extend away from the hub. The robot assembly may comprise a second arm member which may be rotatably connected to the first arm member. The second arm member may be configured to rotate around a second rotational axis that extends in a direction perpendicular or orthogonal to the first rotational axis. The robot assembly may have a wrist joint. The wrist joint may be rotatably connected to the second arm body. The wrist joint may be configured to rotate around about three perpendicular axes. The lid gripper apparatus may be mounted to the wrist joint.

The sensor system may be configured to verify at least one movement made by the robot assembly and/or the lid gripper apparatus. The sensor system may be configured to verify that the at least one protruding or upstanding formation is attached to the lid. The vision system may be configured to verify that a lid is located in the correct position when positioned in the lid storage area or on the pot.

The lid gripper apparatus may comprise at least one vibration device, knocking device and/or impact device configured to transmit vibrational waves and/or impact forces through at least a component of the lid gripper apparatus. The at least one vibration device, knocking device and/or impact device may be configured to transmit vibrational waves and/or impact forces to at least one lid and/or to at least one protruding or upstanding formation on a pot lid gripped by the lid gripper apparatus.

According to a second aspect of the invention, there is provided a lid gripper apparatus for handling pot lids in an aluminium production plant, the lid gripper apparatus comprising:
a support frame;
at least one grip member configured to move between an open condition and a closed condition;
wherein the at least one grip member is configured to grip at least one protruding or upstanding formation on a pot lid when in the closed condition.

The lid gripper apparatus may be for a lid handling system in an aluminium production plant. The at least one grip member may be at least one engaging surface, at least one jaw member or at least one clamp member. The lid gripper apparatus may comprise two or more grip members. The two or more grip members may comprise a stationary grip member and a movable grip member. The movable grip member may be pivotally mounted to the support frame or the stationary grip member. The lid gripper apparatus may comprise at least one actuator configured to move the at least one grip member between an open condition and a closed condition. The at least one actuator may be an electrical, hydraulic or pneumatic piston. The lid gripper apparatus may comprise at least one power source. The lid gripper apparatus may comprise at least one portable power source. The power source may be a battery of fluid reservoir. The two or more grip members may be configured to grip a part of at least one protruding or upstanding formation or a section of at least one protruding or upstanding formation when in a closed position. The two or more grip members may be configured to grip a handle and/or at least one step of a pot lid.

The lid gripper apparatus may be configured to be attached to or mounted on a manipulator arm of a robot assembly. The lid gripper apparatus may be configured to be attached to or mounted on a wrist joint of a robot assembly.

The lid gripper apparatus may comprise at least one vibration device, knocking device and/or impact device configured to transmit vibrational waves and/or impact forces through at least a component of the lid gripper apparatus. The lid gripper apparatus may comprise at least one vibration device. The at least one vibration device may be mounted to the support frame. The at least one vibration device may be mounted to the at least one grip member. The at least one vibration device may be configured to transmit vibrational waves or impact forces through the lid gripper apparatus. The at least one vibration device may be configured to transmit vibrational waves or impact forces through the frame support. The at least one vibration device may be configured to transmit vibrational waves or impact forces through the at least one grip member.

The at least one vibration device may be configured to transmit vibrational waves or impact forces through the frame support and/or at least one grip member to vibrate the lid and push or nudge adjacent lids. The at least one vibration device may be configured to transmit vibrational waves or impact forces to the lid to move adjacent pot lids laterally along the pot. The at least one vibration device may be configured to move or vibrate the lid to contact adjacent pot lids and move the adjacent pot lids laterally along the pot to increase or create a space between the lid and laterally adjacent lids. The lid gripper apparatus may comprise at least one knocking device. The at least one knocking device may be mounted on the frame support and/or the at least one grip member.

The operation of the lid gripper apparatus may be controlled by an autonomous control system. The autonomous control system may be configured to control the actuation of the piston to move at least one grip member between an open condition and a closed condition. The autonomous control system may be configured to control the actuation of the at least one vibration device or the at least one knocking device.

Embodiments of the second aspect of the invention may include one or more features of the first aspect of the invention or its embodiments, or vice versa.

According to a third aspect of the invention, there is provided a method for handling a pot lid in an aluminium production plant; the method comprising:
providing a lid handling system comprising;
and a sensor system;
wherein the sensor system is operable to generate position information to control the position of the at least one manipulator arm and/or lid gripper apparatus;
and gripping at least one protruding or upstanding formation on a pot lid.

The lid gripper apparatus may be mounted at one end of the at least one manipulator arm. The lid gripper apparatus may comprise at least one vibration device, knocking device and/or impact device configured to transmit vibrational waves and/or impact forces through at least a component of the lid gripper apparatus.

Embodiments of the third aspect of the invention may include one or more features of the first or second aspects of the invention or their embodiments, or vice versa.

According to a fourth aspect of the invention, there is provided a method for removing a lid from a pot in an aluminium production plant; the method comprising:
providing a lid handling system comprising;
a robot assembly comprising at least one manipulator arm;
a lid gripper apparatus configured to grip at least one protruding or upstanding formation on a lid, the lid gripper apparatus mounted at one end of the at least one manipulator arm;
and a sensor system;
gripping at least one protruding or upstanding formation on the lid;
lifting the lid; and
verifying, using data acquired by the sensor system, that the lid is attached to the at least one protruding or upstanding formation on the lid.

The method may comprise lifting the lid a first distance from the pot before verifying that the lid is attached to the at least one protruding or upstanding formation. The first distance may range from a 0.5 mm to 1000 mm.

The method may comprise lifting the lid to a lift storage area or unit. The method may comprise verifying that the lid is attached to the at least one protruding or upstanding formation during lifting of the lid to a lift storage area or unit. The method may comprise reporting that a lid is not attached to the at least one protruding or upstanding formation. The method may comprise replacing or repairing the lid. The method may comprise using sensor data to verify that the gripped at least one protruding or upstanding formation is attached to the lid. The method may comprise using sensor data from at least one sensor.

The at least one sensor may be mounted on the lid gripper apparatus and/or the robot assembly. The at least one sensor may be mounted on a support apparatus connected to the robot assembly. The at least one sensor may be mounted on the lid and/or pot.

The at least one sensor selected from the group of: optical sensor, camera, time of flight camera, depth sensor, distance sensor, laser, ultrasound, momentum sensor, accelerometer, rotary position sensor, gyroscopic position sensor, global positioning sensor, infra-red sensor, thermal sensor, load cell, LIDAR, force, weight and/or pressure sensor.

Embodiments of the fourth aspect of the invention may include one or more features of any of the first to third aspects of the invention or their embodiments, or vice versa.

According to a fifth aspect of the invention, there is provided a method of handling pot lids in an aluminium production plant, the method comprising:
providing a lid handling system comprising
a robot assembly comprising at least one manipulator arm;
the robot assembly movably mounted on the movable support;
a lid gripper apparatus mounted at one end of the at least one manipulator arm; and a sensor system;
generating position data for at least one pot lid on the pot;
moving the robot assembly and/or at least one manipulator arm relative to the pot;
actuating the lid gripper apparatus to grip at least one protruding or upstanding formation on the lid; and
moving the at least one lid from the pot.

The method may comprise detecting at least a first positional marker to accurately locate the position of the support. The method may comprise moving the support to align with at least a second position positional marker to accurately relocate the position of the support.

The lid handling system may be movably mounted on a crane. The lid handling system may be movably mounted on a vehicle. The robot assembly may be movably mounted on an overhead crane. The method may comprise moving the overhead crane relative to the pot. The robot assembly may be mounted on a trolley on an overhead crane.

The robot assembly may be movably mounted on a positioning system or a positioning member of a positioning system. The positioning system may be movably mounted on a crane or vehicle. The positioning system may comprise a support having a longitudinal axis. A first positioning member may be movably mounted on the support. The first positioning member may comprise a first axis and a second axis. The first positioning member may be configured to move along the longitudinal axis of the support with the first axis parallel to the longitudinal axis of the support. A second positioning member may be mounted to the first positioning member. The second positioning member may be configured to move transversely to the first axis of the first positioning member.

The method may comprise detecting at least one positional marker to accurately locate and/or move the position of the support, first positioning member and/or a second positioning member. The method may comprise moving the first positioning member and/or a second positioning member to align with at least a second position positional marker to accurately relocate the position of the robot assembly. The positional marker may be selected from the group of barcodes, data matrix codes, quick response codes and/or colour codes.

The method may comprise generating position data for the crane, robot assembly, at least one manipulator arm, lid gripper apparatus and/or at least one formation on the pot lid. The method may comprise detecting the position of the at least one protruding or upstanding formation on the lid using sensor data from the vision system. The method may comprise using data acquired by the vision system to move the lid gripper apparatus into alignment with the at least one protruding or upstanding formation on the pot lid. The method may comprise gripping at least one protruding or upstanding formation on the pot lid. The method may comprise gripping a handle and/or at least one step of the at least one lid.

The method may comprise lifting the at least one lid from the pot. The method may comprise moving the at least one manipulator arm to move the at least one lid from the pot. The method may comprise moving the robot assembly to move the at least one lid from the pot.

Embodiments of the fifth aspect of the invention may include one or more features of any of the first to fourth aspects of the invention or their embodiments, or vice versa.

According to a sixth aspect of the invention, there is provided a method for removing a lid from a pot in an aluminium production plant; the method comprising:
providing a lid handling system comprising;
a robot assembly comprising at least one manipulator arm;
a lid gripper apparatus configured to grip at least one protruding or upstanding formation on the lid, the lid gripper apparatus mounted at one end of the at least one manipulator arm;
gripping at least one protruding or upstanding formation on the at least one lid; and
applying a force and/or energy to the lid via the at least one protruding or upstanding formation to remove dust and/or debris from a surface of the lid.

The force and/or energy may vibrational, impact, shock, shunt, knock and/or shaking. The method may comprise applying the force and/or energy through a component of the robot assembly and/or the lid gripper apparatus to the at least one protruding or upstanding formation. The method may comprise transmitting the force and/or energy through a component of the robot assembly and/or the lid gripper apparatus to the attached at least one protruding or upstanding formation and lid. The method may comprise applying the force and/or energy to the at least one protruding or upstanding formation to assist in dislodging a lid. The method may comprise applying a force and/or energy to the lid handle and/or at least one step.

The method may comprise verifying the removal of dust and/or debris from a surface of the lid before lifting and/or moving the lid from the pot. The method may comprise moving the at least one lid to a lid storage area. The method may comprise performing a pot maintenance operation. The method may comprise moving the at least one lid from the lid storage area to the pot.

Embodiments of the sixth aspect of the invention may include one or more features of any of the first to fifth aspects of the invention or their embodiments, or vice versa.

According to a seventh aspect of the invention, there is provided a method for handling a pot lid in an aluminium production plant; the method comprising:
providing a lid handling system comprising;
a lid gripper apparatus configured to grip at least one protruding or upstanding formation on a pot lid, the lid gripper apparatus mounted at one end of the at least one manipulator arm; and
gripping at least one protruding or upstanding formation on a pot lid;
moving the lid in at least one direction along the pot to contact and/or move adjacent pot lids.

The method may comprise moving the lid in at least one lateral direction along the pot. The method may comprise removing debris on or around the lid by moving the lid in a lateral direction. The method may comprise removing debris located between the lid and adjacent lids or the pot by moving the lid in a lateral direction. The method may comprise moving the lid in a lateral direction to dislodge a stuck lid. The method may comprise moving the lid in a lateral direction to shunt, impact and/or move laterally adjacent lids on the pot support.

The method may comprise moving the lid in a lateral right direction and/or a lateral left direction. The method may comprise increasing or creating a gap or space between the lid and its laterally adjacent lids. The method may comprise creating a space surrounding the lid which is larger than the dimensions of the lid.

The method may comprise lifting the lid a first distance from the pot before moving the lid in at least one direction along the pot to contact adjacent pot lids. The first distance may range from a 0.5 mm to 30 mm. The first distance may be less than the thickness of the lid. The first distance may be approximately equal to 50% the thickness of the lid. The thickness being defined as the distance between the inner (lower) and outer (upper) surfaces of the lid.

The method may comprise moving the lid in a lateral direction before the lid is lifted. The method may comprise monitoring the movement of the lid using the sensor system. The method may comprise monitoring the movement of the lid using the vision system of the sensor system.

Embodiments of the seventh aspect of the invention may include one or more features of any of the first to sixth aspects of the invention or their embodiments, or vice versa.

According to an eighth aspect of the invention, there is provided a method for returning a lid from a pot storage area to a pot in an aluminium production plant; the method comprising:
providing a lid handling system comprising;
a robot assembly comprising at least one manipulator arm;
a lid gripper apparatus configured to grip at least one protruding or upstanding formation on a pot lid, the lid gripper apparatus mounted at one end of the at least one manipulator arm; and
a sensor system;
gripping the lid handle;
moving the lid from the storage area to the pot; and
verifying the placement of the lid on the pot using the sensor system.

The method may comprise verifying the correct placement of the lid on the pot. The method may comprise verifying the lid is a correct alignment on the pot. The method may comprise of adjusting the position of the lid on the pot. The method may comprise of adjusting the position of the lid on the pot until it is in the correct alignment.

Embodiments of the eighth aspect of the invention may include one or more features of any of the first to seventh aspects of the invention or their embodiments, or vice versa.

According to a ninth aspect of the invention, there is provided a pot maintenance system for use in an aluminium production plant; the pot maintenance system comprising;
a crane;
a robot assembly comprising at least one manipulator arm;
the robot assembly movably mounted to the crane;
a lid gripper apparatus configured to grip at least one protruding or upstanding formation on a pot lid; the lid gripper apparatus mounted at one end of the at least one manipulator arm;
at least one pot maintenance functional module movably mounted to the crane; and
a sensor system;
wherein the sensor system is operable to verify that the lid is attached to the at least one protruding or upstanding formation.

The sensor system may be operable to verify the removal of dust and/or debris from the lid before it is placed in a storage area. The sensor system may be operable to verify the removal of dust and/or debris from the lid while the lid is suspended over or near the pot.

The sensor system may be operable to generate position information to control the position of the crane, robot assembly, at least one manipulator arm, at least one pot maintenance functional module and/or lid gripper apparatus. The sensor system may be operable to verify the movement of the crane, robot assembly, at least one manipulator arm, at least one pot maintenance functional module and/or lid gripper apparatus. The system may comprise at least one processor. The at least one processor may be configured to compare sensor data acquired by the sensor system with a movement plan. The at least one pot maintenance functional module may be selected from an anode handling device, a scoop and/or a crust breaker.

Embodiments of the ninth aspect of the invention may include one or more features of any of the first to eighth aspects of the invention or their embodiments, or vice versa.

According to a tenth aspect of the invention, there is provided a method of maintenance for an electrolytic pot in an aluminium production plant, the method comprising:
providing a pot maintenance system comprising:
a movable support;
a robot assembly comprising at least one manipulator arm;
the robot assembly movably mounted to the movable support;
a lid gripper apparatus mounted at one end of the at least one manipulator arm;
at least one pot maintenance functional module movably mounted to the crane; and
a vision system;
generating position data for at least one protruding or upstanding formation on a pot lid on the pot;
moving the movable support, robot assembly and/or at least one manipulator arm relative to pot lid to align the lid gripper apparatus with the at least one protruding or upstanding formation;
actuating the lid gripper apparatus to grip the at least one protruding or upstanding formation;
confirming the lid gripper apparatus is attached to the at least one protruding or upstanding formation; and
moving the at least one lid.

The method may comprise moving the movable support, robot assembly and/or at least one manipulator arm relative to pot lid to align the at least one protruding or upstanding formation with two or more grip members on the lid gripper apparatus.

The method may comprise moving the at least one lid to a lid storage area. The lid storage area may be suspended. The method may comprise generating position data for a spent anode in the pot and/or at least one pot maintenance functional module. The least one pot maintenance functional module may be an anode gripper apparatus, a scoop and/or a crust breaker. The method may comprise breaking a crust over an electrolytic bath in the pot. The method may comprise scooping crust fragments from the electrolytic bath in the pot.

The method may comprise gripping the spent anode. The method may comprise replacing the spent anode with a replacement anode. The method may comprise moving the at least one lid from the lid storage area to the pot.

Embodiments of the tenth aspect of the invention may include one or more features of any of the first to ninth aspects of the invention or their embodiments, or vice versa.

According to an eleventh aspect of the invention, there is provided a system for handling pot lids in an aluminium production plant comprising:
a robot assembly comprising at least one manipulator arm;
a lid gripper apparatus configured to clamp at least one formation on a pot lid, the lid gripper apparatus mounted at one end of the at least one manipulator arm; and
a sensor system;
wherein the sensor system is operable to generate position information to control the position of the at least one manipulator arm and/or lid gripper apparatus.

The at least one formation on a pot lid may be a handle and/or at least one step. The at least one formation on a pot lid may be an edge of the pot lid. The at least one formation may be a formation protruding or upstanding from a surface or side on the lid. The surface may be an upper surface of the pot lid. The formation may be a protruding or upstanding formation.

The lid gripper apparatus may be configured to clamp the formation by applying or exerting a force on at least two surfaces or sides of the at least one formation. The lid gripper apparatus may be configured apply or exert opposing forces on two or more surfaces or sides of the at least one formation.

The lid gripper apparatus may be configured to grip the at least one formation by at least partially encircling or at least partially clamping part of the at least one formation.

Embodiments of the eleventh aspect of the invention may include one or more features of any of the first to tenth aspects of the invention or their embodiments, or vice versa.

According to a twelfth aspect of the invention, there is provided a system for handling pot lids in an aluminium production plant comprising:
a robot assembly comprising at least one manipulator arm;
a lid gripper apparatus configured to grip at least one protruding or upstanding formation on a pot lid, the lid gripper apparatus mounted at one end of the at least one manipulator arm; and
a sensor system;
wherein the sensor system is operable to generate position information to control the position of the at least one manipulator arm and/or lid gripper apparatus wherein the lid gripper apparatus comprises a vibration device, knocking device and/or impact device configured to transmit vibrational waves and/or impact forces through at least a component of the lid gripper apparatus.

Embodiments of the twelfth aspect of the invention may include one or more features of any of the first to eleventh aspects of the invention or their embodiments, or vice versa.

### BRIEF DESCRIPTION OF THE DRAWINGS

There will now be described, by way of example only, various embodiments of the invention with reference to the drawings, of which:

FIG. 1A is an enlarged perspective view of an aluminium production potline and a lid handing system according to an embodiment of the invention;

FIG. 1B is an enlarged side end view of an aluminium production potline and the lid handing system of FIG. 1A;

FIGS. 1C and 1D are top plan and front-end views of the aluminium production potline of FIG. 1A showing pot lids removed;

FIG. 2A to 2C are perspective, side and front-end views of the lid handing system according to an embodiment of the invention;

FIGS. 3A and 3B are enlarged perspective views of the lid handling robot of the lid handing system of FIG. 1A;

FIGS. 4A to 4E are enlarged views of the lid gripper apparatus of the lid handing system of FIG. 1A shown in perspective, side, front end, top plan, and cross-sectional views respectively;

FIGS. 5A and 5B are enlarged perspective and side end views of lid handing system according to an embodiment of the invention showing a lid handling robot mounted to a crane;

FIG. 6 is a schematic of a sensor, processing and control system for positioning and controlling the lid handling system according to an embodiment of the invention;

FIG. 7A is a flowchart of a method of gripping a lid handle using the lid handling system of FIG. 1A according to an embodiment of the invention;

FIG. 7B is a flowchart of a method of verifying a lid is attached to a gripped handle using the lid handling system of FIG. 1A according to an embodiment of the invention;

FIG. 7C is a flowchart of a method of moving a lid to a lid storage area using the lid handling system of FIG. 1A according to an embodiment of the invention;

FIG. 7D is a flowchart of a method of gripping a lid in a lid storage area using the lid handling system of FIG. 1A according to an embodiment of the invention;

FIG. 7E is a flowchart of a method of moving a lid to a pot using the lid handling system of FIG. 1A according to an embodiment of the invention; and

FIGS. 8A to 8C are perspective, top plan and side views of an alternative lid gripper apparatus for use in the lid handing system of FIG. 1A.

### DETAILED DESCRIPTION OF PREFERRED EMBODIMENTS

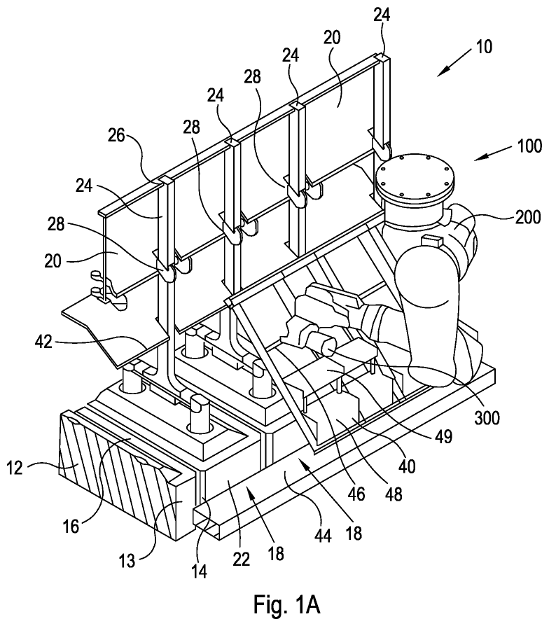

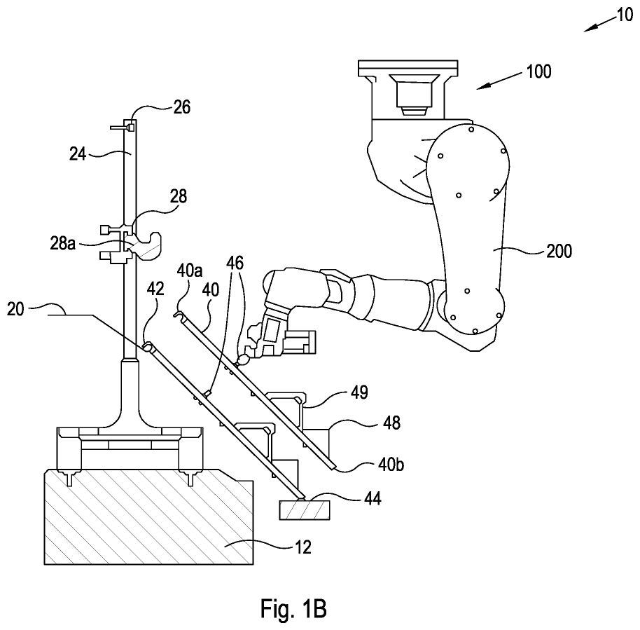

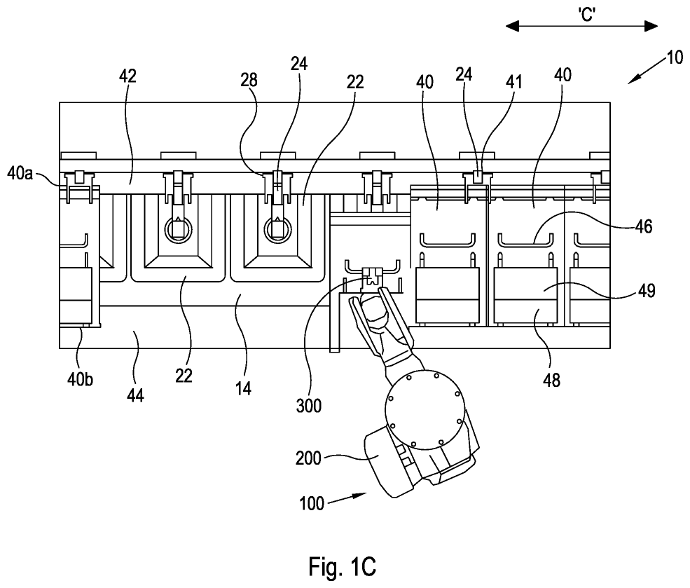

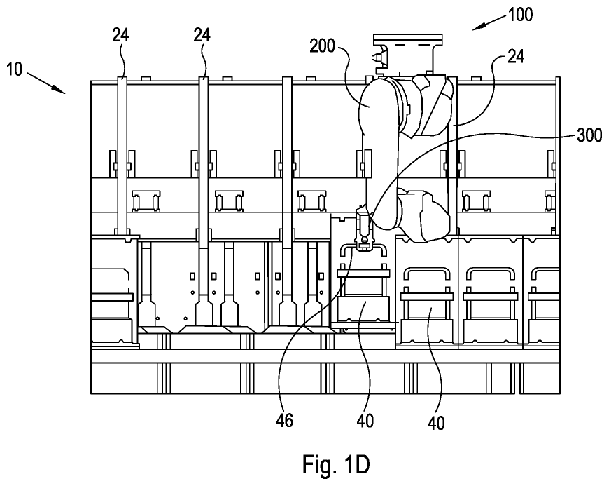

FIGS. 1A, 1B, 1C show a truncated view of an electrolytic cell also known as a pot 10 in a pot room of an aluminium production plant and a lid handing system 100 according to an embodiment of the invention. Aluminium production plants typically comprise several pot rooms each housing hundreds of pots which are arranged in series into potlines. The pot 10 comprises a steel tank 12 with insulating lining 16 made of heat resistance materials. A cathode (not shown) is located at the inner base of the pot. The surface of the lining material and the cathode from a crucible 14 in the pot where an electrolytic bath containing electrolyte consisting of molten cryolite is used to dissolve alumina during aluminium production.

As best shown in FIG. 1A, anode assemblies 18 are removably mounted to the pot support structure 20. Each anode assembly 18 has an anode block 22 made of a carbon material with a support shaft or rod 24 extending from the anode block 22 to allow lifting, handling, and mounting of the anode assembly 18. The pots are electrically connected to other pots in a series by common cathode and common anode conductor connections.

The support shaft 24 has aperture 26 at the distal end which is conventional designed to engage a hook to allow pot room personnel to pull the anode out of the pot. In this example the support shaft 24 is made of copper. The anode assembly 18 is removably secured to the pot support structure 20 by an anode clamp 28 engaging anode clamp hooks 28a mounted on the pot structure. The clamp 28 is configured to allow gradual longitudinal movement of the shaft and anode in a generally downward direction in order to maintain efficiency of the electrolytic process.

The clamp 28 is configured to secure the support shaft to hold the anode assembly 18 at a predetermined height in the electrolytic bath. In order to maintain efficiency of the electrolytic process it is important that the distance or height between a lower surface of the anode block and an upper surface of the cathode is maintained. The anode clamp 28 also prevents lateral movement of the support shaft 24 and anode block 22. The clamp makes an electrical connection between the clamped anode and the pot structure 20.

During the electrolytic process oxide ions from the alumina react with the carbon anode block and gradually consume the carbon anode block forming gaseous carbon dioxide (CO2) in the process. As the carbon anode blocks 22 are gradually consumed the carbon anode blocks 22 are gradually lowered into the crucible 14 to maintain the exposure of the anode 18 to the electrolytic bath. Once consumed the anode 18 is required to be replaced to allow aluminium production to continue. The anodes in the pot are replaced at different times and therefore are in operation for different durations resulting in a different degree of consumption for each spent anode. The accurate positioning of a replacement anode is crucial to maintain the efficiency of the electrolytic process.

The position of the replacement anode and degree of immersion in the electrolytic bath must be adjusted every time such that the height of the lower surface of the replacement carbon anode from the cathode must be the same as the height of the lower surface of the expired carbon anode from the cathode. The lower surface of the replacement carbon 18 anode may also be parallel with the cathode to ensure efficient electrolytic reaction.

As shown in FIGS. 1A and 1B the pot 10 is covered by a plurality of lids 40 arranged side by side. The lids 40 have an upper rim 40a which is supported on an upper ledge 42 on the pot support structure 20. The bottom edge of the lids 40 is supported on a lower ledge 44 on the pot support structure 20. In this example the lids are substantially flat made from steel plate. A handle 46 and two steps 48, 49 are mounted on the outer surface of the lid. The steps 48, 49 enable an operator to climb on the lid to take measurements and perform routine maintenance tasks when the lid is in the closed position. In this example the lid is configured to be gripped and lifted by the handle. However, it will be appreciated that the lid may be gripped and lifted by any other protruding or upstanding formation on the lid such as the steps 48, 49.

The lids 40 are arranged with minimal gap 41 between two adjacent lids to minimise the emission of hazard gasses and dust into the pot room environment. The accurate positioning of the lids also mitigates heat loss from the pot into the pot room. The lids 40 provide a physical barrier between the pot room and the crucible 14 of the pot 10 which protects personnel from accidently falling into the crucible 14 of the pot and being exposed to splashes or sprays of molten cryolite.

A suspended lid handing system 100 comprising a lid handling robot 200 and a lid gripper apparatus 300 is configured to grip the lid handle 46 and move the handle and attached lid.

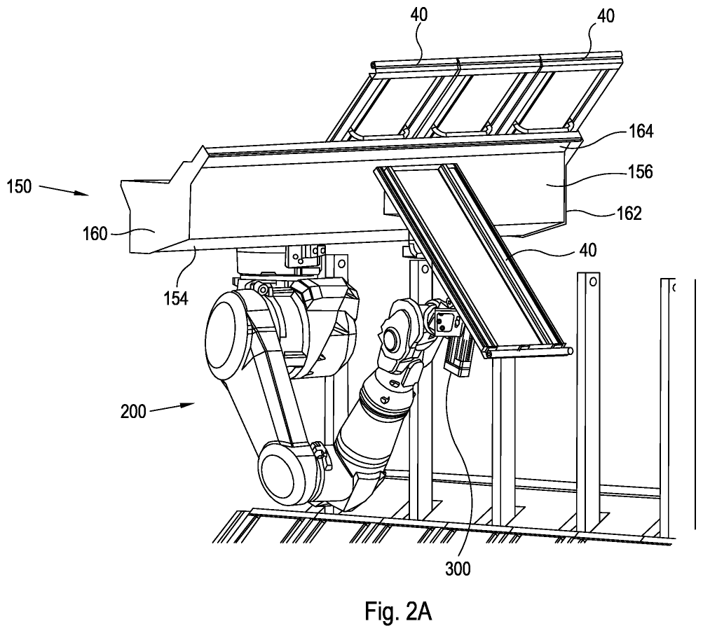

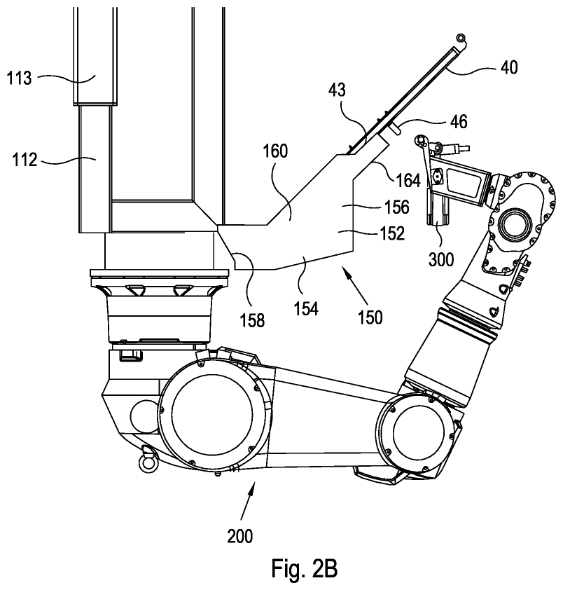

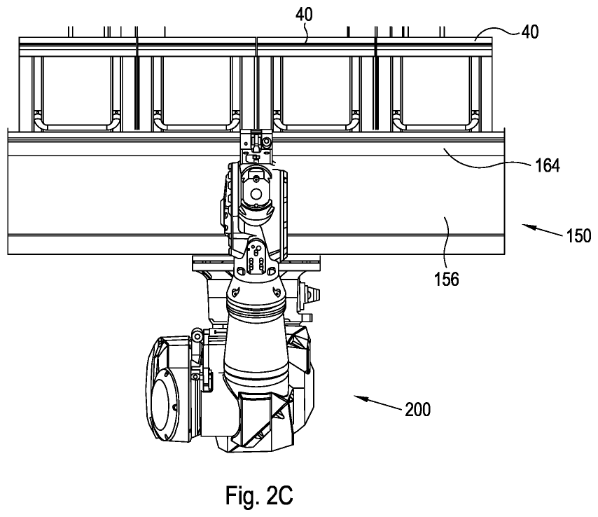

FIGS. 2A to 2C are enlarged perspective, side and front-end views of the lid handing system 100 according to an embodiment of the invention. The lid handing system has a support frame 112 mounted on an overhead support (not shown) such as a crane. The support frame 112 has telescopic members 113 to control the vertical position of the lid handling robot. The overhead support is movable horizontal to move the position of the lid handing system relative to different parts of the pot or to different pots in the potline.

A lid handling robot 200 and a lid storage unit 150 are each mounted on the support frame 112. The lid storage unit 150 is a suspended open container 152 having a base 154, front wall 156, rear wall 158 and side walls 160, 162. The lid storage unit 150 is designed and dimensioned to receive and support one or more lids 40 during a pot maintenance operation such as crust breaking, anode replacement etc, where one or more lids are required to be removed from the pot 10. The front wall 156 of the lid storage unit 150 has an upper rim or lip 164 inclined at approximately 45 degrees to a horizontal plane on which a section 43 of the upper surface of the lid is supported when placed in the container 152.

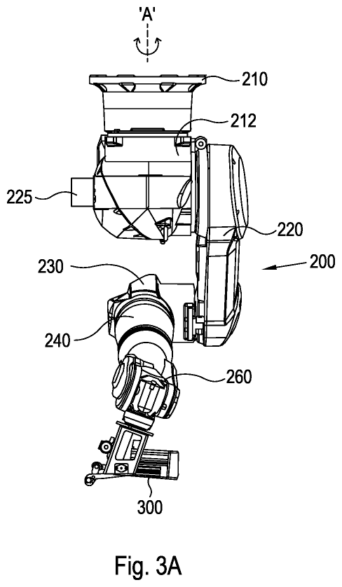

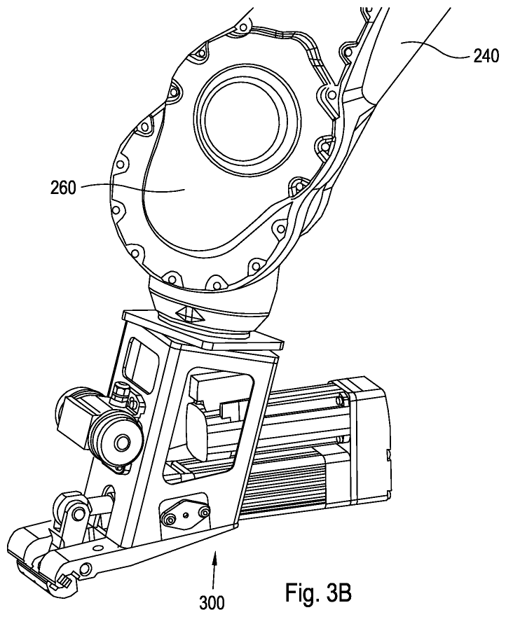

FIGS. 3A and 3B shows enlarged views of the lid handling robot 200 and lid gripper apparatus 300. The lid storage unit 150 and overhead support has been removed for clarity. The lid handling robot 200 comprises a base 210 with a shoulder 212 rotatably mounted to the base 210. The rotation motion of the shoulder 212 allows the robot 200 to rotate in a clockwise or anticlockwise direction about rotational axis “A” shown in FIG. 3A. The base 210 is mounted to support frame 112 which is mounted on overhead support (not shown) such as a crane.

The robot 200 comprises a first arm 220 is pivotably mounted to the shoulder 212. This pivoting motion allows the first arm 220 of the robot to extend forward and retract backward. A second arm 240 is pivotably mounted to the first robot arm 220 by a joint 230. The pivoting motion of the second arm extends the vertical and horizontal reach of the robot 200.

The base 210 has a first motor (not shown) which is configured to rotate the shoulder 212 relative to the base 210. A second motor (not shown) is configured to rotate the first arm 220 relative to the shoulder 212. A third motor (not shown) is configured to rotate the second arm 240 relative to the first arm 220. This arrangement provides the robot 220 with three degrees of freedom. The shoulder 212, first arm 220 and/or second arm 240 may have a brake assembly to hold or lock the shoulder position in relation to base 210, the first arm position in relation to the shoulder position, and/or the second arm position in relation to the first arm position.

As best seen in FIGS. 3A and 3B the second arm 240 supports a wrist joint 260 which provides pitch, yaw and roll movements. The lid gripper apparatus is secured to the wrist joint 260 as a functional end effector device on the robot. The robot 200 has six degrees of freedom capable of locating or positioning the lid gripper apparatus in three linear directions, lateral (X axis) and longitudinal (Y-axis), vertically (Z-axis) and the three angular directions pitch, roll and yaw. In this example a Time of Flight (TOF) camera 225 is mounted on the shoulder 212. The TOF camera 225 captures real time images and distance information between the camera and the subject for each point of the image.

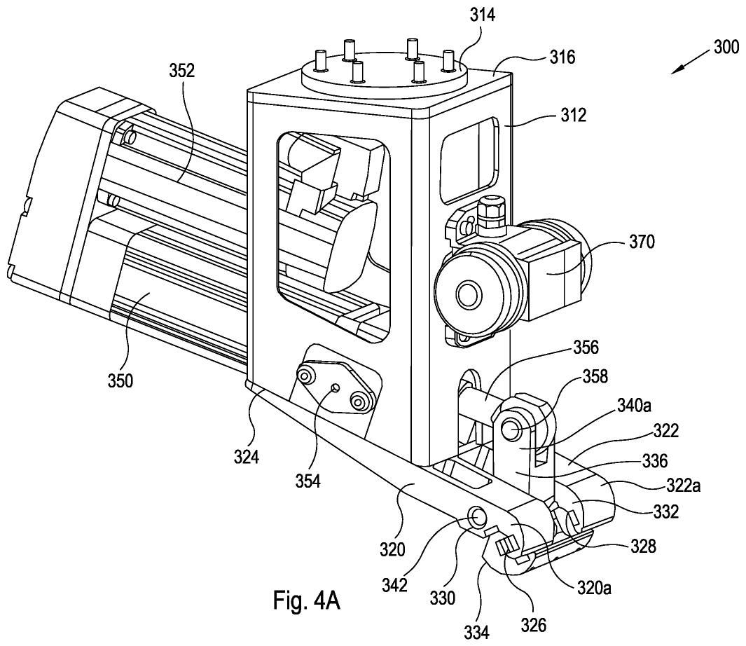

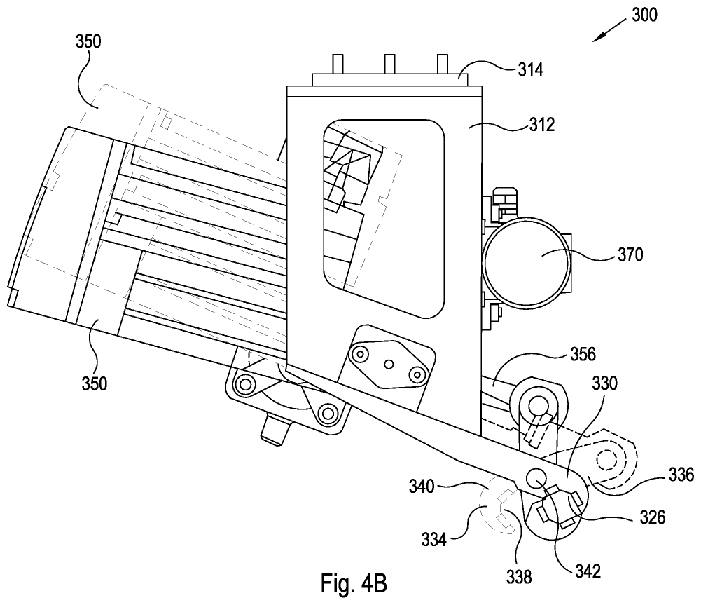

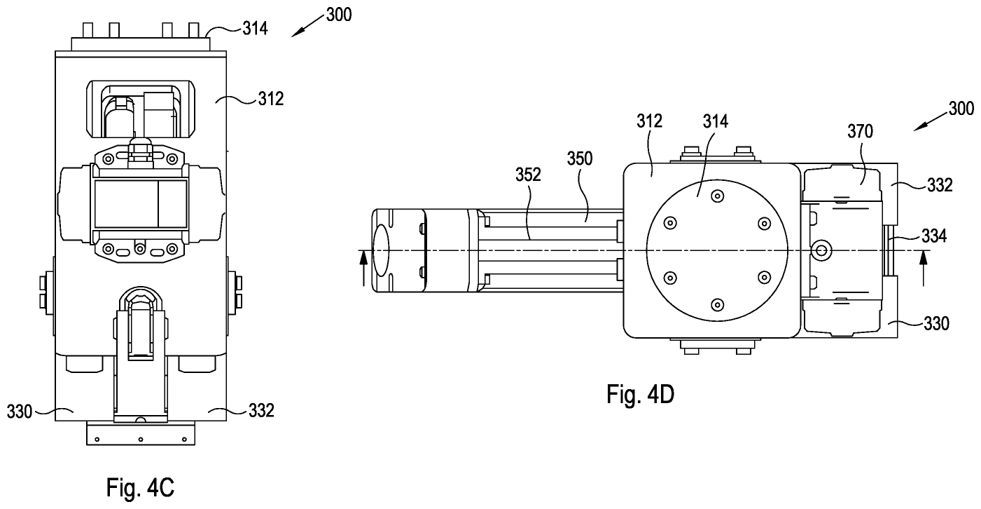

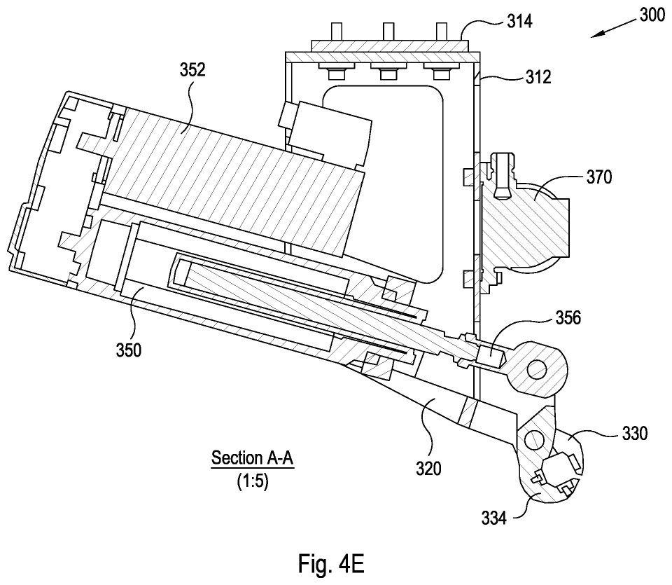

FIGS. 4A to 4E show enlarged views of a lid gripper apparatus 300. The other components of the lid handing system 100 including the lid handling robot has been removed for clarity.

The lid gripper apparatus 300 has a frame 312 with a flange 314 located on an upper surface 316 of the frame. The flange 314 is configured to securely mount the lid gripper apparatus 300 to the wrist joint 260 of the robot assembly 200. The lid gripper apparatus has two arms 320, 322 secured to a lower surface 324 of the frame 312. Each arm has a semi-circular recess 326, 328 at a distal end 320a, 322a forming two stationary jaw members 330, 332. The stationary jaw members 330, 332 are configured to be upper jaw members.

A movable jaw member 334 is configured to be a lower jaw member or companion jaw member to the stationary jaw members. The movable jaw member 334 has an arm 336 with a semi-circular recess 338 at one end 340. The movable jaw member 334 is movable between the stationary jaw members and is pivotally mounted on the arms 320, 322 by pivot 342. The movable jaw member is configured to be pivotally movable towards and away from the stationary jaw members 330, 332.

A reciprocating piston 350 and connected power supply 352 are pivotally mounted to the frame by pivot pin 354. In this example the piston is an electrical piston. However, it will be appreciated the alternative piston types and their corresponding power supplies may be used. The piston 350 has an arm 356 pivotally mounted to a second end 340a of the arm of the movable jaw member 334 by pivot 358. A vibrator 370 is mounted on an outer surface of the frame 312. The vibrator 370 is configured to produce vibratory waves in the frame 312. The vibratory waves are transmitted through the frame, through the upper jaw members 330, 332 to an attached lid handle or other upstanding or protruding formation.

A vision system monitors the positioning and operation of the lid handling operation. In this example the vision system comprises a TOF camera 225. In this example the TOF camera system 225 is located on the robot shoulder at fixed coordinates and provides a frame of reference to accurately monitor the positioning of the wrist joint 260 and the lid gripper apparatus 300. Using real time images and distance information within the TOF camera data, a processing unit and control system can accurately control the operation of the wrist joint 260 and the lid gripper apparatus 300. In this example the movable jaw member 334 is configured to operate in a fail-closed arrangement. In the event of a loss of power, pneumatics, hydraulic and/or a control signal is interrupted or lost the movable jaw member 334 is moved to or maintains a closed jaw position. This means that a gripped lid would not be released or dropped in the event of a loss of power, pneumatics, hydraulic and/or a control signal.

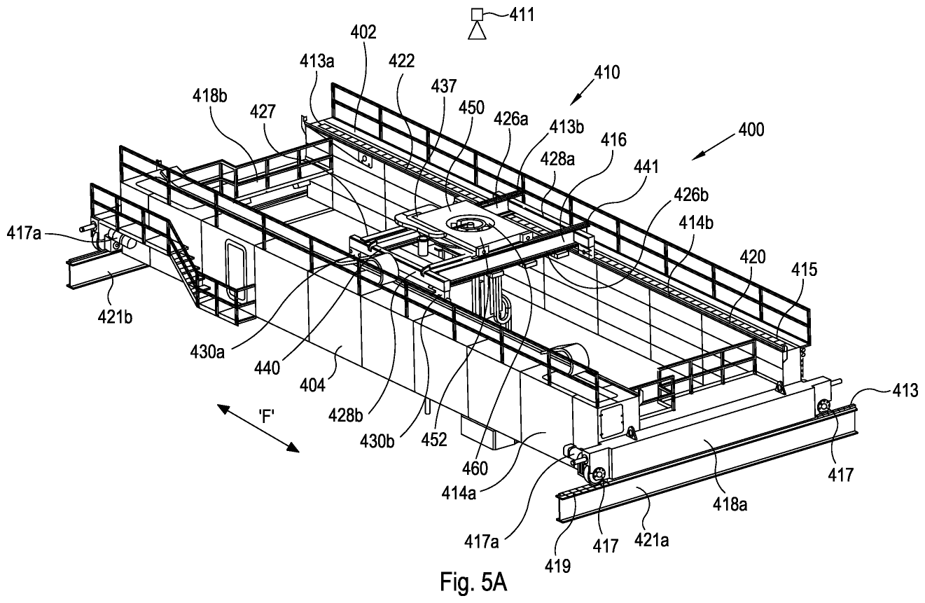

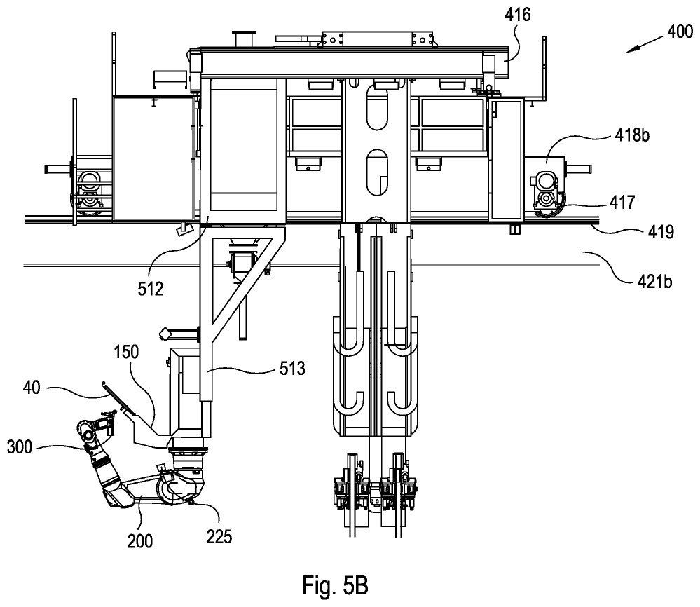

FIGS. 5A and 5B are side and perspective views of the lid handling system 400 according to an embodiment of the invention. The lid handling system 400 is similar to the lid handling system 100 described in FIGS. 1A to 4B and will be understood from the description of FIGS. 1A to 4B. However, in the lid handling system 400 comprises an overhead crane 402 to which the lid handling robot 200 and a lid storage unit 150 are each mounted via a support frame 512 and telescopic members 513.

The overhead crane 402 has two parallel runway beams 421a and 421b on which rails 419 are mounted. The runway beams 421a and 421b support a positioning system 410 to which the lid handling support frame 512 is attached. The two support beams 414a, 414b act as crane bridge girders and form a crane bridge 404 which is movably mounted on support rails 419 forming an overhead crane 402. In this example the runway beams form part of the building structure. However, alternatively the runway beams 421a and 421b may be mounted on moveable such as column supports movable in three axes. The runway beams 421a and 421b may be mounted on stationary column supports.

The positioning system 410 has cross beams 418a, 418b at each end of the support beams 414a, 414b. Rail wheels 417 are mounted on the cross beams 418a, 418b and are configured to engage the rail 419 on the runway beams 421a and 421b. Actuation of motors 417a move the rail wheels 417 to allow movement of the positioning system 410 along the longitudinal length of the runway beams 421a and 421b. A plurality of QR codes is arranged at known positions along the longitudinal length of the runway beam 421a. A camera system 411 captures image data of the QR codes to accurately locate the 16 position of the positioning system 410 along the longitudinal length of the runway beams 421a and 421b.

The positioning system has a trolley 416 movably mounted relative to the support beams 414a, 414b. The support beams 414a, 414b have a longitudinal guide 420 located on an upper surface 415 of the support beams 414a, 414b. The longitudinal guide 420 spans the longitudinal length of the support beams 414a, 414b. In this example the longitudinal guide 420 is a toothed rack 422. A plurality of QR codes 413a are arranged at known positions along the longitudinal length of the support beams 414b. The camera system 411 captures the image of the QR codes 413a to accurately locate the position of the trolley along the longitudinal length of the support beam 414b.

The trolley 416 has a trolley frame 440 comprising two girder supports 426a, 426b and two drive supports 428a, 428b. The two drive supports 428a, 428b are connected to the supports 426a, 426b as end supports with the drive supports 428a, 428b arranged substantially parallel with the frame support beams 414a, 414b.

The two supports 426a, 426b span the distance between the parallel support beams 414a, 414b. The drive supports 428a, 428b have pinion gears 430a, 430b at each end. The pinion gears 430a, 430b are rotatably mounted on the drive supports 428a, 428b. The trolley frame 440 supports reversible motors 427. Each pinion gear 430a, 430b has teeth which cooperate with teeth on the rack 422 such that when the motors 427 rotates the pinion gear 430a the pinions 430a, 430b travel along the rack 422 which moves the first trolley 416 along the support beams 414a, 414b shown as arrow “F” in FIG. 5A

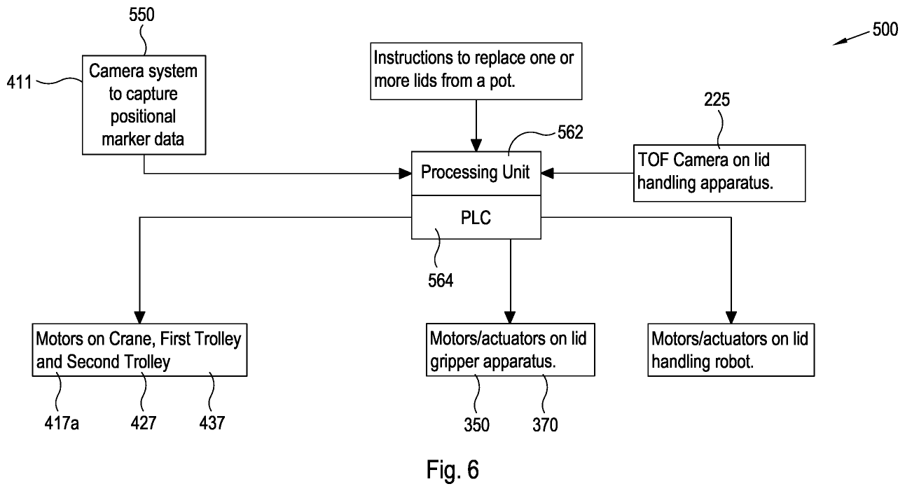

The motors are connected to a control unit 564 (discussed further in relation to FIGS. 6) to allow the accurate movement of the trolley 416 along the support beams 414a, 414b to position the lid lifting robot adjacent to pot lids to be lifted. The control unit uses data from the camera system 411 to allow remote and/or automated movement and positioning of the trolley 416 to within 1 mm accuracy.

Optionally, the trolley 416 supports a second trolley 450. Each of the supports 426a, 426b of the trolley frame 440 has a longitudinal guide 441 located on an upper surface of the support beams 426a, 426b. The longitudinal guide 441 spans the longitudinal length of the supports 426a, 426b. In this example the longitudinal guide 441 is a rack. A plurality of positional markers 413b are arranged at known positions along the longitudinal length of a support beam 426a. The camera system 411 is configured to capture image data of the positional markers to accurately locate the position of the second trolley 450 along the longitudinal length of the support beam 426a, 426b. In this example the positional markers are QR codes 413b. The second trolley 450 has a base 452 made of steel plate. The second trolley has a motor 437 connected to the control unit 564 to allow the accurate movement of the second trolley along the along the supports 426a, 426b of the trolley frame 440. The control unit is configured to allow remote and/or automated movement of the second trolley.

Optionally, a rotatable platform 460 is rotatably mounted on base 452 of the second trolley 450. The rotatable platform 460 is supported by gearing assembly. A drive assembly (not shown) is configured to rotate the platform. The drive assembly is connected to the control unit 564 to allow the accurate rotational movement of the platform 460. The control unit is configured to allow remote and/or automated movement rotational movement of the platform 460.

Optionally the lid handling robot and/or one or more components of an anode handling system may be attached to the second trolley or the rotatable platform 460. The rotatable platform 460 acts as turntable enabling an attached lid handling robot or one or more attached components of an anode handling system to rotate relative to the base 452. The control unit uses data from the camera system 411 to allow accurate movement and positioning of the positioning system, first trolley and/or second trolley to within 1 mm accuracy.

Optionally the motors may be servomotors which may be configured to move and position the support, first and/or second position members with an accuracy of up to 0.5 mm.

FIG. 5B shows an enlarged side view of the lid handling system 400 where the lid handling robot 200 and a lid storage unit 150 are each mounted to the trolley 416 via a support frame 512.

Optionally the support frame 512 has telescopic members 513 to control the vertical position of the lid handling robot. The telescopic members 513 are operated by the control system to extend and lower the robot assembly to its work position when a lid handling operation is required. Before moving the trolley 416, the control system retracts telescopic members 513 to lift the robot assembly to stow condition. Restrictions may be put in place to prevent movement of the trolley 416 when the robot assembly in the deployed lowered condition.

The control system moves the trolley 416 along a horizontal axis to move the position of the robot relative to different parts of the pot or to different pots in the potline. When trolley 416 or crane 402 is automatically moved to the pot and correctly positioned for a pot maintenance operation such as a replacement of an anode, the robot assembly is lowered to deployed condition the vision system uses machine vision to detect the correct lid and correct lid handle.

The lid gripper apparatus 300 is guided by a sensor in the vision system such as a TOF camera 225 to grip the handle. A feedback signal from the gripping tool and/or vision system confirms that the lid is correctly attached to the robot assembly and is ready to be securely lifted. The vibrator mounted to the lid gripper apparatus 300 will start vibrating the lid to remove hazardous dust in order to reduce the spreading this dust in the working area and assist in dislodging a lid if it stuck.

The TOF camera 225 in the vision system will follow the movement path of the robot assembly when lifting the lid, to allow full control of the robot movement to confirm that the lid and lid handle are being lifted. The cover is deposited in the lid storage unit mounted on the trolley 416. The lid is placed securely in the lid storage unit. The TOF camera 225 provides a feedback signal to the control system verifying that the lid is present in the lid storage unit.

The crane 402 is located in one position during the lid handling operation to reduce crane and robot maneuvering time. When the pot maintenance operation such as a replacement of an anode is finished the robot assembly moves the lids one by one from the lid storage unit and accurately locates them using the vision system in place on the pot. The TOF camera 225 may precisely measure positional data of the lid handling system control movement of trolley 416 along the crane to accurately position the lid handling robot 200 and a lid storage unit 150 relative to the pot and lids. This mitigates the requirement to reposition a supporting crane or vehicles thereby saving time and costs.

FIG. 6 shows a schematic diagram of a sensor, processing and control system for positioning and controlling the lid handling system.

The system 500 has a sensor system comprising a camera system 550 configured to capture image data of positional markers located at known positions on the crane, positioning apparatus, the first trolley and/or the second trolley. In this example the camera system 411 is mounted above the crane. The positional markers are QR codes 413, 413b and are located along the longitudinal length of runway beam 421a, support beam 414b and support beam 426a.

Optionally, components of the pot room including equipment, pots, and/or lids may comprise one or more positional markers such as QR codes to assist in the sensor system accurately positioning the lid handling system in the pot room or relative to selected pots and/or pot lids. This may also assist in the sensor system identifying and moving around known obstacles in the workspace. The system 500 has a processing unit 562 in a programmable logic controller (PLC) 564. The processing unit 562 receives the captured QR image data from the camera system 411. The processing unit 562 identifies the QR code as a specific location on the crane, positioning apparatus or the first trolley.

To locate the lid handling robot attached to the first trolley at position adjacent to a specific pot lid the vision system 500 locates the positioning apparatus at a desired position on the crane. The processing unit identifies the corresponding QR code associated with the new location on the crane. The PLC 564 controls the motors 417a to move the positioning apparatus along the longitudinal length of runway beam 421a, 421b to reach the new location on the runway beam 421a, 421b of the crane. Optionally the processing unit uses real time feedback from the first camera system 411 to confirm the positioning apparatus is located at the correct position on the runway beam 421a using captured QR code data.

The system 500 locates the first trolley at a desired position on the positioning apparatus. The processing unit identifies the corresponding QR code associated with the new location on the positioning apparatus. The PLC controls the motors 427 to move the first trolley along the longitudinal length of support beams 414a, 414b to reach the new location on the support beams 414a, 414b of the positioning apparatus. Optionally the processing unit uses real time feedback from the first camera system 411 to confirm that the first trolley 416 is located at the correct position on the support beam 414a using captured QR code data.

Although the movement of the positioning system and first trolley are described as a sequential movement it will be appreciated that the sequence order may be different. It will also be appreciated that the movement of the positioning system and/or first trolley may be simultaneous, synchronised or have overlapping action movements.

The system 500 has a vision system 520 configured to accurately obtain accurate positional data on components of the lid handling system and their surrounding environment.

The vision system 500 comprises a time of flight (TOF) camera 225 mounted on the lid handling robot. The TOF camera provides real time images and distance information between the camera and the lid for each point of the image. The TOF camera is located on the robot at fixed coordinates and provides a frame of reference to accurately monitor the positioning of the wrist joint 260 and the lid gripper apparatus 300. Using the TOF camera data, the processing unit 562 and PLC 564 accurately control the operation of the wrist joint 260 and the positioning of the lid gripper apparatus 300. The TOF camera data is processed by the processor unit 562 to localise the components of the lid handling robot and the lid gripper apparatus with respect to the pot and/or lid.

The TOF camera 225 identifies the dimensions of the lid and formations on the lid such as the lid handle and steps. The layout of the pot lids and dimensions of the handles and steps on the lids may have a high degree of variation. During their lifetime some lids, handles and steps may be damaged, deformed or repaired resulting in non-uniform lids on the pot. Due to the high degree of heterogeneity in the location of the pots and the position of the handle or steps on the pots the camera system 225 is required to identify the position of the lid, handle and/or steps for each lid before it is gripped. In this example the TOF camera 225 accurately identifies the position of the handle 40. The camera system 225 monitors the distance of lid gripper apparatus 300 from the lid handle and relays that information to the processor unit 562 and PLC 564 which moves the lid gripper apparatus 300 into alignment with the lid handle.

The TOF camera 225 is capable of tracking the jaw position of the lid gripper apparatus irrespective of the orientation or position of the arms of the robot. The TOF camera 225 monitors the position of the robot assembly with high precision. The camera system 225 tracks the position and movement of the lid handling robot and lid gripper apparatus.

The PLC controls the operation of the lid gripper apparatus to move the jaw members to a closed position to grip the lid handle. The PLC controls the lateral movement and/or vibration of the lid, lifting and movement of the lid between the storage area unit and the pot. The TOF camera data verifies that the lid handling device is in alignment with the handle of the lid, the lid has been successfully gripped, that debris and/or dust has been removed and that the lid has been successfully moved and lifted.

Before or during a lid lifting movement, the camera system 225 may be used to confirm that the lid handle has been gripped and gripped securely. The camera system 225 may be used to confirm that the lid is also attached and lifted with the lid handle.

Additionally, or alternatively the vision system comprises one or more load cells on the robot. The loads cells may be located at the base, shoulder and/or joints of the robot and configured to measure forces acting on the base, shoulder, first arm, joint, second arm and/or wrist joint. One or more loads cell may be located at the jaws of the lid handing device to verify that the lid handle has been gripped and gripped securely. Additionally, or alternatively the vision system comprises one or more weight sensing or momentum sensing sensors.

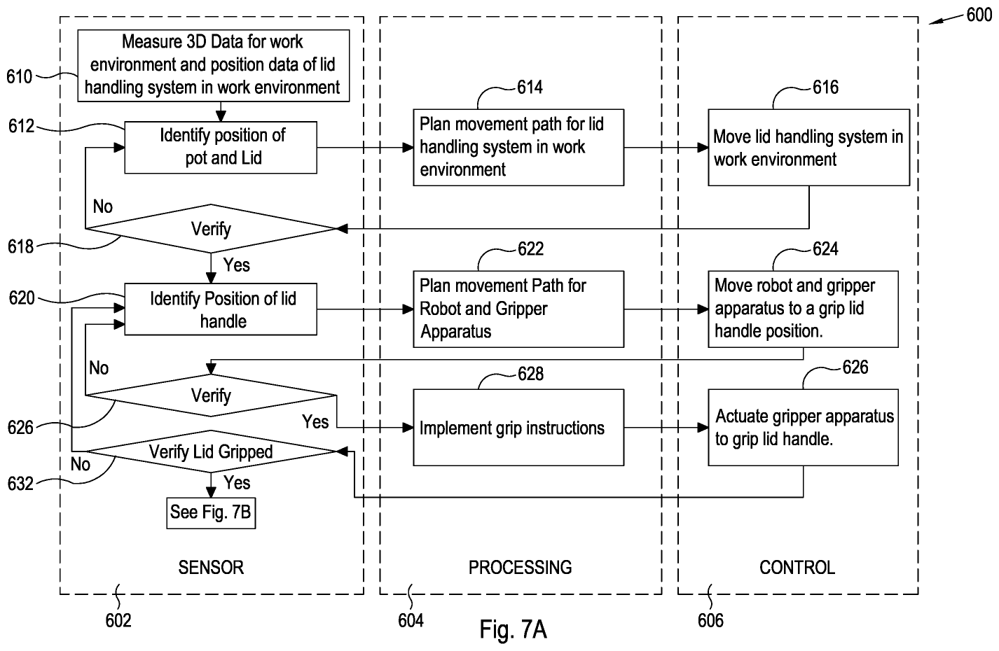

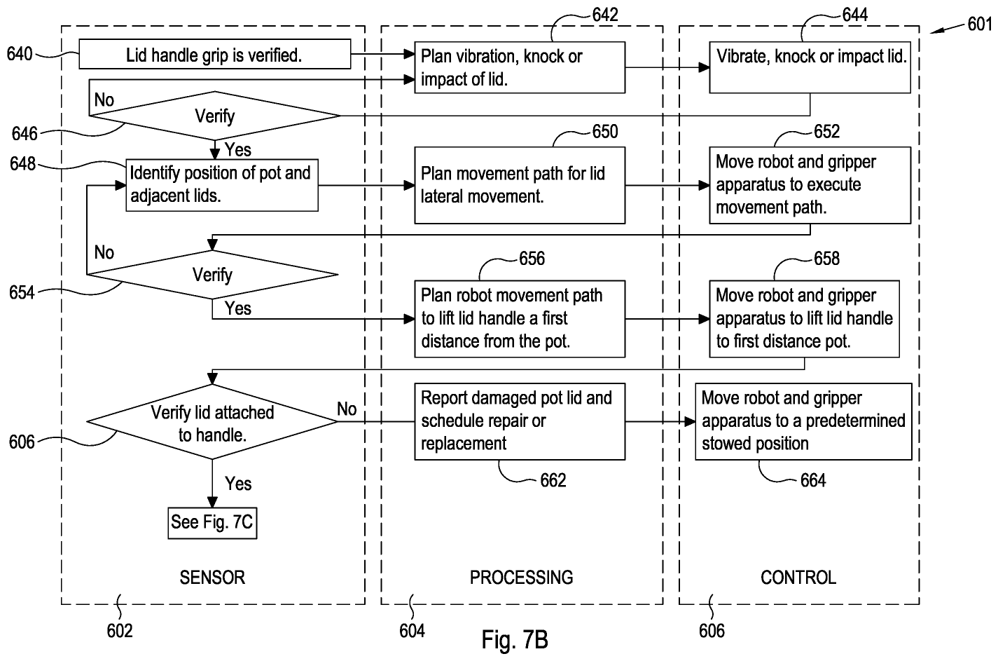

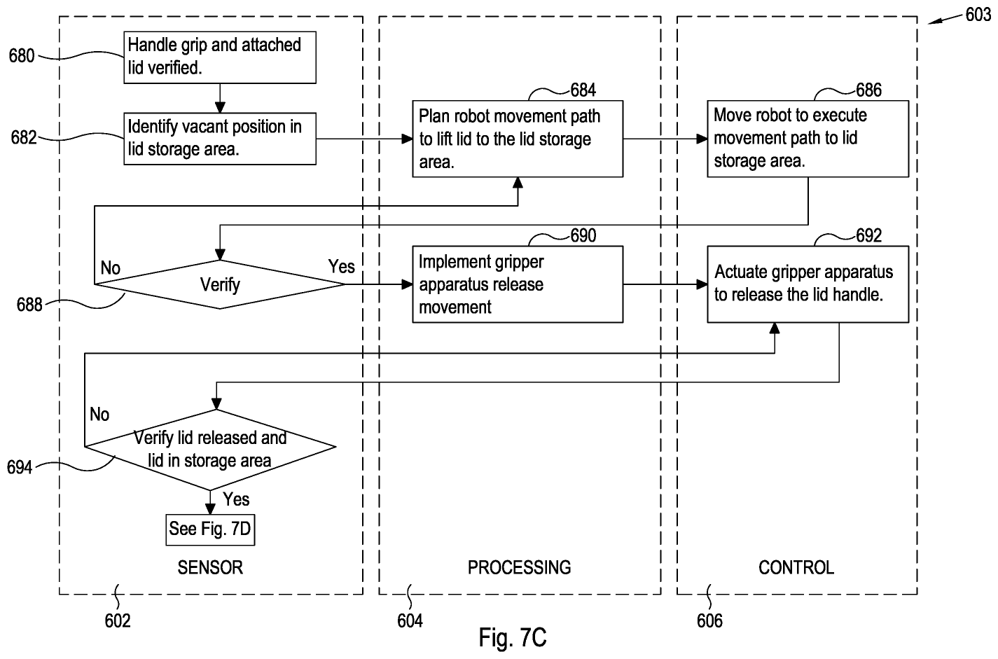

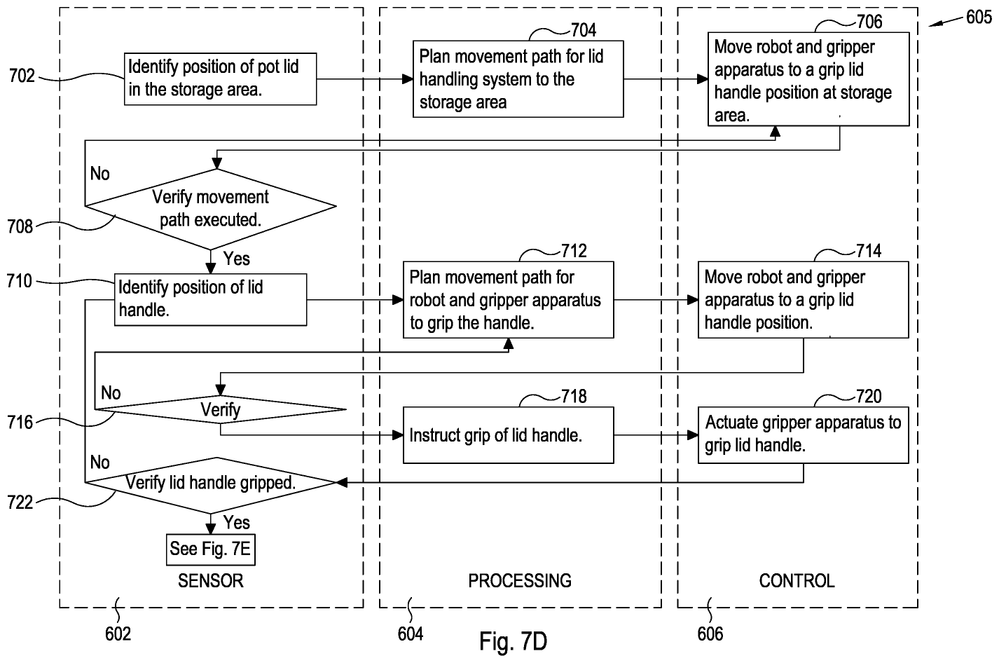

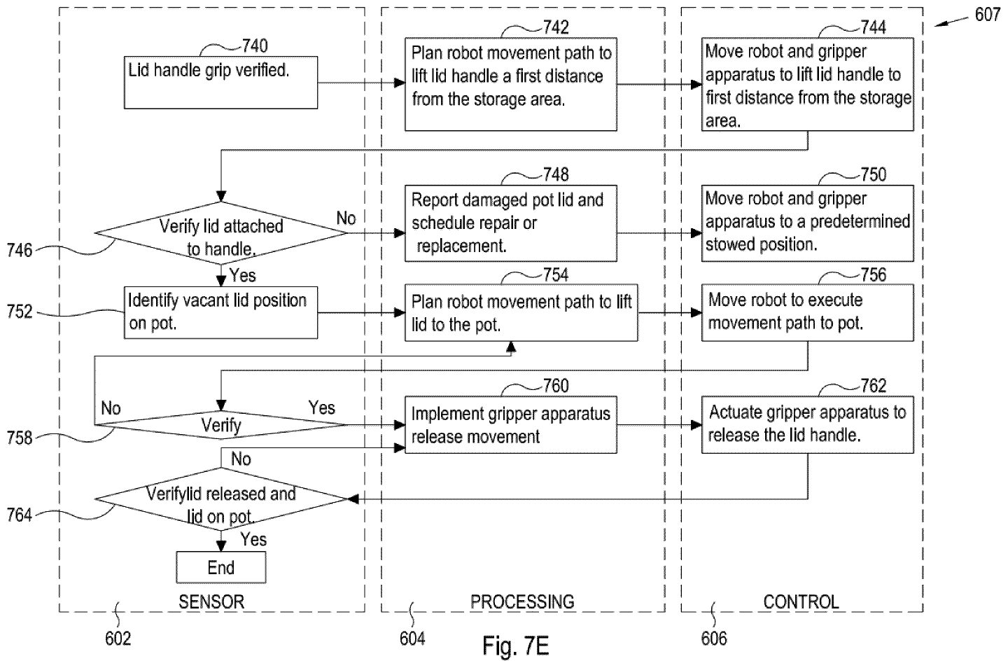

FIGS. 7A to 7E show flowcharts describing the operational steps of the lid handling system 100. In the FIGS. 6A to 6E the tasks are arranged into sensor tasks 602, processing tasks 604 or control tasks 604.

In the first stage 610 one or more sensors measures 3D data for the work environment of the pot room. The vision system also generates 3D position information of components of the crane, robot assembly, the lid gripper apparatus in relation to the pot and pot room. The sensor system may be configured to generate 3D position information of potential obstacles in a work area surrounding a pot of interest.

In 612, the sensor system generates 3D position information of a pot and identifies specific pot and pot lid where a pot maintenance operation is to be performed. Using the sensor data, the processor in stage 614 plans a movement path for the crane and lid handling system in the work environment. The control unit at stage 616 implements the movement path controlling the movement of the crane on which the lid handing system 100 is mounted along a horizontally axis to locate the lid handing system roughly adjacent to one or more lids to be removed.

The sensor system monitors the movement of the crane and lid handing system to verify in step 618 that the movement path has been executed correctly. If the plan is not executed correctly then steps 612 to 616 are repeated to locate the lid handing system roughly adjacent to one or more lids to be removed. When movement path has been correctly executed by the control system the vision system in step 620 identifies the position of the lid handle 40.

Using the sensor data, the processor in stage 622 plans a movement path for the lid handling robot assembly and lid gripper apparatus. In step 624 the control system controls the extension of telescopic members 113 to lower the robot assembly into a working deployed condition. The lid handling robot 200 extends and manoeuvres its shoulder, first arm, second arm and/or wrist joint to move from a stowed condition to a deployed condition to align the jaw members 330, 332, 334 of the lid gripper apparatus 300 with the handle 46 of the lid 40.

The piston 350 is actuated to extend the piston arm 356. In the extended arm position as shown in the dashed line in FIG. 4B, the arm 336 of the moveable jaw member 334 rotates about the pivot pin 342 in a clockwise direction which moves the lower moveable jaw member 334 away from the upper jaw members 330, 332. The lid handling robot 200 extends and manoeuvres its shoulder, first arm, second arm and/or wrist joint to manoeuvre the lid gripper apparatus such that the lid handle is adjacent to the inner surface of the recesses 326, 328 of stationary jaw members 330, 332.

The vision system comprises a TOF camera which monitors the movement of the lid handling robot 200 and lid gripper apparatus to verify in step 626 that lid gripper apparatus has been brought into alignment with the lid handle. If it is not aligned, then steps 620 to 624 are repeated to locate bring it into alignment.

When lid gripper apparatus has been brought into alignment with the lid handle the processor in step 628 instructs the control unit to grip the handle. The control unit in step 630 control the actuation of piston 350 to retract the piston arm 356. In the retracted arm position as shown in FIG. 4B, the arm 336 of the moveable jaw member 334 rotates about the pivot pin 342 in an anti-clockwise direction which moves the lower moveable jaw member 334 towards from the upper jaw members 330, 332. When the piston 350 is in the fully retracted position the lid handle 40 is at least partially surrounded and gripped by the upper jaw members 330, 332 and lower moveable jaw member 334.

In step 632 the vision system verifies that the lid handle has been gripped by the lid gripper apparatus using the TOF camera system. Additionally, or alternatively the sensor system may use load cell data to confirm the lid has been gripped by the lid gripper apparatus.

If the lid handle has not been gripped by the lid gripper apparatus, then steps 620 to 630 are repeated until the lid handle has been gripped by the lid gripper apparatus.

FIG. 7B shows a flowchart 601 of the operation steps of the lid handling system once it has been verified (Step 640) that the lid handle has been gripped by the lid gripper apparatus.

In step 642, the processor in plans a vibration, knock or impact of the lid. In this embodiment the lid gripper apparatus has a vibrator 370 to vibrate the lid. However, it will be appreciated the lid handling apparatus may apply a force or form of energy on the lid. The robot assembly by vibrate, impact, shunt or apply a shock wave to the lid. Additionally, or alternatively device capable of applying a force or form of energy to the lid may be located on a component of the lid handling apparatus. The device may be a knocking or impact tool used to apply an impact force or shock wave to the lid to remove hazardous dust from the lid and assist in dislodging a lid if it stuck.

Optionally the control system in step 644 actuates the vibrator 370 to produce vibratory waves in the frame 312. The vibratory waves are transmitted through the frame, through the upper jaw members 330, 332 to the attached lid handle 46 and lid 40. The vibratory waves vibrate the lid 40 causing harmful dust or debris on the lid to loosen any dust or debris attached to the lid enabling the dust or debris to be removed before the lid is moved. The vibration of the lid 40 also breaks any deposits that may bind the lid to adjacent lids or to the pot structure or otherwise hinder the movement or removal of the lid 40. Optionally the vision system in step 646 verifies that the dust or debris has been removed from the lid using the camera system. If the dust or debris has not been removed, then steps 642 and 644 may be repeated.

Optionally the TOF vision system in step 648 identifies the position of the lid, the adjacent lids. The vision system measures the gap between the lid and neighbouring lids either side of the lid. Using the sensor data, the processor in stage 650 plans a lateral movement path for the lid to be moved. The control system at step 652 manoeuvres the robot shoulder, first arm, second arm and/or wrist joint to move the attached lid in a substantially lateral or sidewards directions to shunt, abut and/or move the position of adjacent lids shown as arrow “C” in FIG. 1C. This lateral or sidewards movement adjusts the size of the gaps 43 between the adjacent lids and widens the clearance space around the lid to be removed. This may allow accurate and precise placement of the lid when it is replaced. The TOF camera system monitors the movement of the lid and verifies if lateral movement path is complete. If it is not, then the steps 648 to 652 may be repeated to laterally move the lid. When the lateral movement path is complete the processor in step 654 plans a robot movement path to lift the lid handle a first distance from the pot to verify that the lid is attached to the lid handle. The control unit in step 656 actuates the robot to lift the lid handle. It will be appreciated that step 654 and 656 of planning and lifting the lid handle a first distance may be performed before the step of moving the lid in a lateral or sidewards movement. The first distance may be less than the thickness of the lid. The distance may be approximately equal to 50% the thickness of the lid. This may allow the lid to suspended over the pot structure but still close enough to the pot structure to shunt, abut and/or move the position of adjacent lids when moved in a lateral or sidewards movement.

The vision system verifies that the lid is attached to the lid handle. In this example the vision system uses a TOF camera to visually confirm the movement of the lid with the lid handle. However, alternatively or additionally the vision system may comprise one or more load cells on the robot. The loads cells may be located at the base, shoulder and/or joints of the robot and configured to measure forces acting on the base, shoulder, first arm, joint, second arm and/or wrist joint. The loads cells are capable of measuring the weight of the lid. If the vision system fails to detect the presence of a lid attached to the lid handle a report may be generated to schedule a repair or replacement. The control unit moves the robot and gripper to a predetermined stow condition to allow the lid to be repair or replaced.

FIG. 7C shows a flowchart 603 of the operation steps of the lid handling system once it has been verified (Step 680) that the lid is attached to the lid handle gripped by the lid 17 gripper apparatus.

In step 682 the vision system identifies a vacant position for a lid in the lid storage unit. Using the TOF camera data, the processor at step 684 plans a robot movement path to lift the lid to the lid storage unit. The control system implements the movement path. As best shown in FIG. 1B, the lids 40 are originally positioned on the pot 10 at an angle of approximately 45 degrees to the horizontal plane. The lid handling robot 200 is operated to manoeuvres its shoulder, first arm, second arm and/or wrist joint to lift the attached lid to the lid storage unit 150.

During the lifting operation from the pot 10 to the lid storage unit 150 the lid 40 is pivoted through an arc of approximately 270 degrees. This movement path by the robot minimises the number of movements performed by the robot to move the lids between the pot 10 and the lid storage unit 150. By minimising the movement of the robot, the time required to lift and store or replace a lid from storage is reduced which reduces the period of time the pot is left uncovered and toxic emission enter the pot room. The lid is placed in the lid storage unit 150 with the lower edge of the lid 40b adjacent to the corner formed between the base and the rear wall 158. The portion 43 of the front surface of the lid is supported by the lip 164 of the lid storage unit 150. The vision system monitors the movement of the robot to verify that if follows the movement path. If the vision system detects that the robot is not following the movement path steps 686 and 688 are repeated.

Once the lid is placed in the lid storage unit 150, the processor unit at step 670 instructs the release of the gripper apparatus which the control unit implements in step 672. The control unit monitors the release. If it detects the lid handle is still attached to the gripper apparatus, then steps 670 and 672 are repeated. The lid handling system may be actuated to remove multiple lids and place them in the lid storage unit before performing a pot maintenance operation as shown in FIG. 1A.

FIG. 7D shows a flowchart 700 of the operation steps of the lid handling system to grip a lid located in a lid storage unit 150.

After a pot maintenance operation such as an anode replacement operation has been completed the vision system in step 702 identifies the position of the lid in the storage unit. The processor plans a movement path for the lid handling system to the lid storage unit 150. The lid handling robot is operated by the control system in step 704 to manoeuvre its shoulder, first arm, second arm and/or wrist joint to align the lid handling system with the lid in the lid storage unit 150. The TOF camera system verifies that this alignment was correctly implemented, otherwise steps 704 and 706 are repeated.

In step 710 the TOF camera identifies the position of the lid handle. The processor in step 712 plans a movement path for the robot assembly and lid gripper apparatus to the align with the lid handle. In step 714 the control system controls the lid handling robot 200 to extends and manoeuvre its shoulder, first arm, second arm and/or wrist joint to align the jaw members 330, 332, 334 of the lid gripper apparatus 300 with the handle 46 of the lid 40. The piston 350 is actuated to extend the piston arm 356. In the extended arm position as shown in the dashed line in FIG. 4B, the arm 336 of the moveable jaw member 334 rotates about the pivot pin 342 in a clockwise direction which moves the lower moveable jaw member 334 away from the upper jaw members 330, 332.

The lid handling robot 200 extends and manoeuvres its shoulder, first arm, second arm and/or wrist joint to manoeuvre the lid gripper apparatus such that the lid handle is adjacent to the inner surface of the recesses 326, 328 of stationary jaw members 330, 332. The TOF camera monitors the movement of the lid handling robot 200 and lid gripper apparatus to verify in step 716 that lid gripper apparatus has been brought into alignment with the lid handle. If it is not aligned, then steps 710 to 714 are repeated to locate the lid handle and bring the gripper apparatus into alignment.

When lid gripper apparatus has been brought into alignment with the lid handle the processor in step 718 instructs the control unit to grip the handle. The control unit in step 720 controls the actuation of piston 350 to retract the piston arm 356. In the retracted arm position as shown in FIG. 4B, the arm 336 of the moveable jaw member 334 rotates about the pivot pin 342 in an anti-clockwise direction which moves the lower moveable jaw member 334 towards from the upper jaw members 330, 332. When the piston 350 is in the fully retracted position the lid handle 40 is surrounded and gripped by the upper jaw members 330, 332 and lower moveable jaw member 334.

In step 722 the vision system verifies that the lid handle has been gripped by the lid gripper apparatus using the TOF camera system. Additionally, or alternatively the sensor system may use load cell data to confirm the lid has been gripped by the lid gripper apparatus. If the lid handle has not been gripped by the lid gripper apparatus, then steps 710 to 720 are repeated until the lid handle has been gripped by the lid gripper apparatus.

FIG. 7E shows a flowchart 701 of the operation steps of the lid handling system to return the lid to the pot once it has been verified (Step 740) that the lid handle has been gripped by the lid gripper apparatus.

The processor in step 742 plans a robot movement path to lift the lid handle a first distance from the lid storage unit to verify that the lid is attached to the lid handle. The control unit in step 744 actuates the robot to lift the lid handle. The vision system verifies that the lid is attached to the lid handle. In this example the vision system uses the TOF camera 225 to visually confirm the movement of the lid with the lid handle.

Optionally, if the vision system fails to detect the presence of a lid attached to the lid handle a report may be generated to schedule a repair or replacement. The control unit may move the robot and gripper to a predetermined stow condition to allow the lid to be repair or replaced.

In step 754 the sensor system identifies the vacant position for a lid on the pot. Using the sensor data, the processor at step 756 plans a robot movement path to lift the lid to the lid storage unit. The control system implements the movement path. The lid handling robot 200 is operated to manoeuvres its shoulder, first arm, second arm and/or wrist joint to lift the attached lid from the lid storage unit 150 to the pot.

During the lifting operation from the lid storage unit 150 to pot the lid 40 is pivoted through an arc of approximately 270 degrees. This movement path by the robot minimises the number of movements performed by the robot to move the lids between the pot 10 and the lid storage unit 150. By minimising the movement of the robot, the time required to lift and store or replace a lid from storage is reduced which reduces the period of time the pot is left uncovered and toxic emission enter the pot room. The lid is placed on pot positioned on the pot 10 at an angle of approximately 45 degrees to the horizontal plane. The sensor system monitors the movement of the robot to verify that if follows the movement path and placement on the pot. If the sensor system detects that the robot is not following the movement path steps 754 and 756 are repeated.

Once the lid is placed on the pot, the processor unit at step 760 instructs the release of the gripper apparatus which the control unit implements in step 762. The control system monitors the release of the lid and lid handle from the robot. If it detects the lid handle is still attached to the gripper apparatus, then steps 760 and 762 are repeated. The lid handling system may be actuated to return multiple lids to the pot in sequential operations.

The sensor system may use the TOF camera and/or an infra-red camera to confirm that the lid has be successfully returned to the pot and is in the correct position. The infra-red camera may be capable of detecting heat loss through gaps from a misaligned lid. The placed lid is returned within a 10 mm tolerance of the correct position.

The lid handling robot 200 is either repositioned to grip another lid or moved from a deployed condition to a stowed condition.

It will be appreciated that the operational steps described above in relation to FIGS. 6 and 7A to 7E are examples of the invention and that one or more steps may be omitted or added and/or that the sequence of the steps may be different and/or steps may overlap in time.

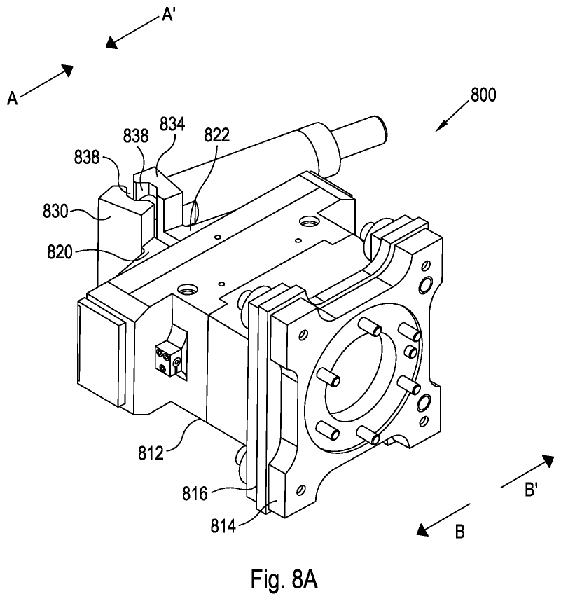

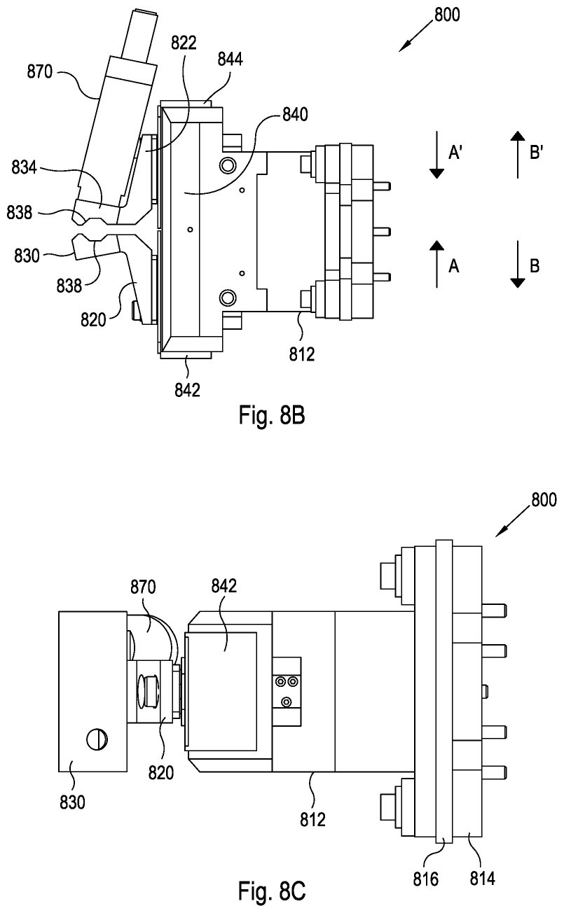

FIGS. 8A to 8C show enlarged views of an alternative lid gripper apparatus 800 that may be used with the other components of the lid handing system 100 including the lid handling robot 200 and the sensor system 500 in place of the lid gripper apparatus 300.

The lid gripper apparatus 800 has a frame 812 with a flange 814 located on a surface 816 of the frame. The flange 814 is configured to securely mount the lid gripper apparatus 800 to the wrist joint 260 of the robot assembly 200.

The lid gripper apparatus 800 has a first jaw member 830 mounted on a first support arm and a second jaw member 834 mounted on a second support arm 822. The first support arm 820 and second support arm 822 are configured to be movable towards each other to a jaw closed or grip position. The direction of travel of the first support arm 820 to a jaw closed or grip position is shown as arrow “A″ in FIG. 8A”. The direction of travel of the second support arm 822 to a jaw closed or grip position is shown as arrow “A′” in FIGS. 8A and 8B. The second support arm 820 and second support arm 822 are configured to be movable away from each other to a jaw open or release position. The direction of travel of the first support arm 820 to a jaw open or release position is shown as arrow “B″ in FIG. 8A”. The direction of travel of the second support arm 822 to a jaw open or release position is shown as arrow “B′” in FIGS. 8A and 8B.

The movable jaw members 830 and 834 each has a longitudinal recess or groove 838. In this example the longitudinal recess has a semi-circular shape designed to grip a lid handle. However, it will be appreciated that other recess shapes may be used to grip other formations or objects on the lid such as a part of a lid step.

The lid gripper apparatus has a valve system 840. The valve system has a spring arranged to urge the support arms 820 and 822 towards each other to a jaw close or grip position as shown as arrows “A and A′ in FIG. 8A. The first support arm 820 is connected to a first piston 842 and second support arm 822 is connected to a second piston 842. The actuation of the first and second piston overcome the spring force of the spring to move the support arms 820 and 822 away from one another to a jaw open or release position as shown as arrows “B and B′ “in FIG. 8A”. In this example the valve system 840 is pneumatically operated. However, it will be appreciated the alternative valve system and their corresponding power supplies may be used such as hydraulically or electrically operated systems. In this example the valve system and spring are configured in a fail-closed arrangement. The support arms 820 and 822 are maintained in a jaw closed or grip position as shown as arrows “A and A′ in the event of a loss of power, pneumatics, hydraulic and/or a control signal is interrupted or lost. This means that a gripped lid would not be released or dropped in the event of a loss of power, pneumatics, hydraulic and/or a control signal. This may mitigate risks to personnel and infrastructure from lids being accidently released and falling on personnel, into pots or onto infrastructure due to a loss power, pneumatics, hydraulic and/or a control signal.

A vibrator 870 is mounted on the second jaw member 834 and is configured to transmit vibratory waves through the second jaw member 834 to an attached lid handle 46 and lid 40 to remove harmful dust or debris on the lid and breaks any deposits that may bind the lid to adjacent lids or to the pot structure or otherwise hinder the movement or removal of the lid 40.

In use the valve system is actuated to move the first and second jaw members to a jaw open position. The lid gripper apparatus 800 is manoeuvre to locate a part of a pot lid such as a handle between the first and second jaw members. The valve system is de-actuated to move the first and second jaw members to a jaw grip position clamping the lid handle between the first and second jaw members. In order to release the lid, the valve system is actuated to move the first and second jaw members to a jaw open position.

Optionally the lid storage unit has at least one sensor connected to the control system to identify the presence and/or number of the lids in the storage device. The sensor may be configured to confirm that the lid is stored in the storage unit in the correct orientation.

It will be appreciated that the sensor system or components of the sensor system may be located on a different part or on multiple parts of the apparatus, system, or components of the pot room. The sensor system or components of the sensor system may be located part of the robot assembly, lid handling apparatus, lifting apparatus, crane and/or pot support structure. The sensor system may comprise two or more sensors. The sensor system may use vision and laser system for verification and distance measurement.

In the above-described embodiments, a vibration device is located on the lid gripper apparatus. However, it will be appreciated the lid handling apparatus may apply a force or form of energy on the lid by moving the robot assembly to vibrate, impact, shunt or apply a shock wave to the lid. Additionally, or alternatively a device capable of applying a force or form of energy to the lid may be located on a component of the lid handling apparatus. The device may be a knocking or impact tool used to apply an impact force or shock wave to the lid to remove hazardous dust from the lid and assist in dislodging a lid if it stuck.

In the above examples the lid gripper apparatus is described as gripping a lid handle. However, it will be appreciated that the lid gripper apparatus may be configured to grip any protruding or upstanding formation on the lid such as a lid step.

In the above examples the lid handling robot is described as being mounted on the positioning apparatus. It will be appreciated that the lid handling robot may be mounted or positioned on components of the positioning system such as the support, first trolley or second trolley. It will be appreciated that the lid handling robot may be mounted on a crane or a vehicle.

In the above examples the vision system uses QR codes to accurately position the crane and trolleys. However, it will be appreciated that alternative positional markers may be used including data matrix codes, bar codes, coloured markings and/or tapes.

In the above examples the positional markers are described as being located on one support beam. It will be appreciated that corresponding positional markers may be located on multiple support beams or on multiple surfaces of support beams to provide redundancy in the event that one or more positional markers a support beam surface become obscured with dirt or damaged. In the above examples the camera system for detecting the positional markers is described as being above the crane. It will be appreciated that different sensor types may be used capable of detecting the positional markers. It will be appreciated that the at least one sensor may be mounted or positioned on components of the positioning system such as the support, first trolley or second trolley. The at least one sensor may be located or mounted on a component of the crane or vehicle supporting the positioning system. The at least one sensor may be located or mounted on a component of a surrounding structure such as a floor, walls and/or roof.

Embodiments of the invention may allow the safe removal and replacement of a pot lid quickly and accurately. It is important that the removal and replacement of lids be performed as quickly as possible as the lids confine toxic gasses created during the smelting process in the enclosed environment and direct the gasses to a ventilation system to reduce exposure to personnel in the pot room.

In addition, the enclosed environment provided by the lid may protect the anode from oxidation from the air in the pot room and assist in maintaining the high temperature of around 950° C. required in the electrolyte bath.

The present invention may increase the life span of the lids and components of the pot support structure and mitigate lid maintenance and the associated maintenance cost. The lid handling apparatus may mitigate wear or damage to the lids by accurately gripping and handling the lids consistently and carefully each time a pot operation is required and deposits the lids into a storage unit carefully without impacts to the lids or components of the pot support structure.

By storing the lids in an elevated storage position the lids are not an obstacle to equipment or personnel and damage to the lids is mitigated.

Embodiments of the invention may remove dust and debris from the lids before the lid is moved to a storage area so that only the lids are removed from the pot structure and that no unwanted objects or components of the bath are also lifted which can fall and damage equipment or present a safety hazard.

The system may allow crane movement, lid alignment, gripping, lifting and replacement of lids autonomously. It does not require personnel in the vicinity of the pots during hazardous pot maintenance operations.

The invention provides a system for handling pot lids in an aluminium production plant. The system comprises a robot assembly comprising at least one manipulator arm and a lid gripper apparatus configured to grip a pot lid. The lid gripper apparatus is mounted at one end of the at least one manipulator arm. The system also comprises a sensor system. The sensor system is operable generate position information to control the position of the at least one manipulator arm and/or lid gripper apparatus.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. A system for handling pot lids in an aluminium production plant comprising:
a robot assembly comprising at least one manipulator arm;
a lid gripper apparatus configured to grip at least one protruding or upstanding formation on a pot lid, the lid gripper apparatus mounted at one end of the at least one manipulator arm; and
a sensor system;
wherein the sensor system is operable to generate position information to control the position of the at least one manipulator arm and/or lid gripper apparatus; wherein the lid gripper apparatus comprises at least one vibration device, knocking device and/or impact device configured to transmit vibrational waves and/or impact forces through at least a component of the lid gripper apparatus.

2. The system according to claim 1 wherein the at least one protruding or upstanding formation on a pot lid is a handle and/or at least one step on a pot lid.

3. The system according to claim 1 wherein the lid gripper apparatus is configured to contact at least two surfaces or sides of the at least one protruding or upstanding formation to clamp the at least one protruding or upstanding formation.

4. The system according to claim 1 wherein the robot assembly is movably mounted on a support, vehicle, crane, positioning system or at least one positioning member of a positioning system.

5. The system according to claim 4 wherein the support, vehicle, crane, positioning system, or positioning member comprise a plurality of positional markers.

6. The system according to claim 5 wherein the plurality of positional markers is selected from the group comprising barcodes, data matrix codes, quick response codes and/or colour codes.

7. The system according to claim 5 wherein the sensor system comprises at least one sensor is configured to detect at least one of the plurality of positional markers to accurately locate and/or move the position of the support, vehicle, crane, positioning system and/or at least one positioning member.

8. The system according to claim 1 wherein the sensor system is configured to generate 3D position information of a pot, a pot lid, a lid handle, a lid step, a potline, a pot room and/or a part of the pot room, the robot assembly, at least one manipulator arm and/or lid gripper apparatus.

9. The system according to claim 1 wherein the sensor system comprises at least one sensor selected from the group comprising optical sensor, vision system, camera, time of flight camera, depth sensor, distance sensor, laser, ultrasound, momentum sensor, accelerometer, rotary position sensor, gyroscopic position sensor, global positioning sensor, infra-red sensor, thermal sensor, load cell and/or LIDAR.

10. The system according to claim 9 wherein the at least one sensor of the sensor system is mounted on the robot assembly, at least one manipulator arm and/or lid gripper apparatus.

11. The system according to claim 1 wherein the sensor system comprises a vision system comprising at least one optical sensor.

12. The system according to claim 1 comprising at least one processing unit configured to process a movement path for the robot assembly, the lid gripper apparatus, the lid and/or the at least one protruding or upstanding formation based on the position information generated by the sensor system.

13. The system according to claim 1 comprising at least one control unit configured to move a crane, positioning system, at least one positioning member of a positioning system, robot assembly, at least one manipulator arm of the robot and/or the lid gripper apparatus in relation to the pot, lid and/or at least one protruding or upstanding formation.

14. The system according to claim 1 wherein the lid gripper apparatus comprises at least one grip member operable to move between an open condition and a closed condition.

15. A lid gripper apparatus for a lid handling system, the lid gripper apparatus comprising:
a support frame;
at least one grip member configured to move between an open condition and a closed condition;
wherein the at least one grip member is configured to grip at least one protruding or upstanding formation on a pot lid when in the closed condition wherein the lid gripper apparatus comprises at least one vibration device, knocking device and/or impact device configured to transmit vibrational waves and/or impact forces through at least a component of the lid gripper apparatus.

16. A method for handling a pot lid in an aluminium production plant: the method comprising:
providing a lid handling system comprising;
a robot assembly comprising at least one manipulator arm;
a lid gripper apparatus mounted at one end of the at least one manipulator arm;
and a sensor system;
wherein the sensor system is operable to generate position information to control the position of the at least one manipulator arm and/or the lid gripper apparatus; wherein the lid gripper apparatus comprises at least one vibration device, knocking device and/or impact device configured to transmit vibrational waves and/or impact forces through at least a component of the lid gripper apparatus;
and gripping at least one protruding or upstanding formation on a pot lid.

17. The method according to claim 16 comprising using data acquired by the vision system to move the lid gripper apparatus into alignment with the at least one protruding or upstanding formation on the pot lid.

18. The method according to claim 16 comprising verifying that the lid is attached to the at least one protruding or upstanding formation on the lid using data acquired by the sensor system.

19. The method according to claim 16 comprising moving a support, vehicle, crane, positioning system and/or at least one positioning member of a positioning system on which the robot assembly is mounted.

20. The method according to claim 19 comprising detecting at least one positional marker on a support, vehicle, crane, positioning system and/or at least one positioning member of a positioning system to accurately locate the position of the robot assembly.

21. The method according to claim 19 comprising moving the support, vehicle, crane, positioning system and/or at least one positioning member of a positioning system support to align with at least one positional marker to accurately relocate the position of the robot assembly.

22. The method according to claim 16 comprising detecting the position of the at least one protruding or upstanding formation on the lid using sensor data from the vision system.

23. The method according to claim 16 comprising applying a force and/or energy to the lid via the at least one protruding or upstanding formation to remove dust and/or debris from a surface of the lid.

24. The method according to claim 16 comprising lifting the lid a first distance from the pot before moving the lid in at least one direction to move adjacent pot lids laterally along the pot to increase or create a space between the lid and the laterally adjacent lids.

25. The method according to claim 16 comprising moving the lid to a lid storage area and verifying the correct placement of the lid in the lid storage area using the sensor system.

26. The method according to claim 16 comprising gripping at least one protruding or upstanding formation of a lid located in a lid storage area and returning the lid to a pot and verifying the correct placement of the lid on the pot using the sensor system.
